(19) United States
(12) Patent Application Publication
(10) Pub. No.: US 2014/0055479 A1
(43) Pub. Date: Feb. 27, 2014

(54) CONTENT DISPLAY PROCESSING DEVICE, CONTENT DISPLAY PROCESSING METHOD, PROGRAM AND INTEGRATED CIRCUIT

(71) Applicants: Ryouichi Kawanishi, Kyoto (JP); Keiji Icho, Osaka (JP)

(72) Inventors: Ryouichi Kawanishi, Kyoto (JP); Keiji Icho, Osaka (JP)

(73) Assignee: Panasonic Corporation, Osaka (JP)

(21) Appl. No.: 14/004,248

(22) PCT Filed: Jan. 11, 2013
(86) PCT No.: PCT/JP2013/000069

§ 371 Date: Sep. 10, 2013

(30) Foreign Application Priority Data
Mar. 14, 2012 (JP) 2012-057019

(51) Int. Cl. G06T 5/00

(52) U.S. Cl. CPC G06T 5/00
USPC 345/581

(57) ABSTRACT

A content display processing device includes a display unit, a content acquisition unit, a characteristic determination unit and a display control unit. The content acquisition unit acquires pieces of content. The attribute information acquisition unit acquires pieces of attribute information, each piece of attribute information being acquired from one or more of the pieces of content and indicating an attribute thereof. The characteristic information determination unit determines a piece of characteristic information based on the pieces of attribute information, the piece of characteristic information pertaining to pieces of target content among the pieces of content and indicating an attribute which is characteristic thereof. The display control unit controls the display unit to display the pieces of target content based on the piece of characteristic information. Through the above configuration, pieces of target content can be arranged and displayed on arrangement axes which change in accordance therewith.

### TECHNICAL FIELD

The present invention relates to an art of displaying content.

### BACKGROUND ART

In recent years, photographs and videos have become increasing easy to capture due to widespread availability of DSCs (Digital Still Cameras) such as compact cameras, mobile phones with camera functions, digital video cameras and the like. Recording media used to store data, for example of captured images, are also increasing in capacity. Furthermore, with the development of social media, users are now able to share content with a wide range of other people. As a consequence of the above developments, a user now typically possesses a large number of pieces of content, and thus a large amount of time and effort by the user may be required for use and management of the content.

In light of the above situation, there is interest in an art of display control processing wherein content is displayed in list format in a manner such that a user can efficiently find a desired piece of content. Each list may for example correspond to a capture time, a capture location or a content tag input by a user, such as an event name. For example, a display method is commonly known in which pieces of content are arranged along three axes of time, location and people, and the arranged pieces of content are displayed in a three dimensional selection UI. Furthermore, by modifying thumbnails of images in accordance with the number of images or the number of appearances of a person in the images, navigation display can be performed in a manner such that a user can easily search for a desired piece of content (refer to Patent Literature 1 for example).

In another commonly known method, pieces of content are categorized into a plurality of categories based on time information and location information, and through simple user operations preview display is performed in a manner which shows which category each of the pieces of content is categorized into (refer to Patent Literature 2 for example).

### CITATION LIST

### Patent Literature

[Patent Literature 1] Japanese Patent Application Publication No. 2008-529118
[Patent Literature 2] Japanese Patent Application Publication No. 2011-210138

### SUMMARY OF INVENTION

### Technical Problem

Unfortunately, in methods such as in Patent Literature 1 and 2, pieces of content can only be arranged on fixed axes such as time, location and people. Therefore, the above methods do not necessarily provide a method for displaying the pieces of content in a manner which is easily viewable and searchable by the user.

In consideration of the above problem, the present invention aims to provide a content display processing device and method which allow arrangement and display of pieces of display processing target content, in other words pieces of content which are targets for display processing, using various arrangement axes which change in accordance with the pieces of display processing target content.

### Solution to Problem

In order to solve the above problem, a content display processing device relating to the present invention comprises: a display unit; a content acquisition unit configured to acquire a plurality of pieces of content; an attribute information acquisition unit configured to acquire one or more pieces of attribute information, each of the pieces of attribute information being acquired from one or more of the plurality of pieces of content and indicating an attribute thereof; a characteristic information determination unit configured to determine a piece of characteristic information based on the pieces of attribute information, the piece of characteristic information pertaining to one or more pieces of target content among the plurality of pieces of content and indicating an attribute which is characteristic thereof; and a display control unit configured to control the display unit to display the pieces of target content, based on the piece of characteristic information.

### Advantageous Effects of Invention

Through the content display processing device relating to the present invention, pieces of display processing target content (pieces of target content) can be arranged and displayed on arrangement axes which change in accordance with the pieces of display processing target content.

### BRIEF DESCRIPTION OF DRAWINGS

FIG. 1 is a block diagram illustrating a content display processing system relating to a first embodiment.

FIG. 2 illustrates an example of device metadata.

FIG. 3 illustrates an example of analysis metadata.

FIG. 4 illustrates an example of usage metadata.

FIG. 5 illustrates an example of data structure of an attribute information storage sub-unit relating to the first embodiment.

FIG. 6 illustrates an example of usage information relating to the first embodiment.

FIG. 7 illustrates an example of data structure of a usage information storage sub-unit relating to the first embodiment.

FIG. 8 is for explanation of a calculation method for attribute information usage weightings relating to the first embodiment.

FIG. 9 is for explanation of a calculation method for attribute information priorities relating to the first embodiment.

FIG. 10 illustrates an example of data structure of an attribute information priority storage sub-unit relating to the first embodiment.

FIG. 11 illustrates an example of data structure of a characteristic category storage sub-unit relating to the first embodiment.

FIG. 12 is a flowchart illustrating an overview of operations relating to the first embodiment.

FIG. 13 illustrates an example of user operation and content display relating to the first embodiment.

FIG. 14 is a flowchart illustrating operations of attribute information acquisition and attribute information reliability setting relating to the first embodiment.

FIG. 15 is a flowchart illustrating operations of usage information acquisition, attribute usage information calculation and usage weighting calculation relating to the first embodiment.

FIG. 16 is a flowchart illustrating operations of attribute information priority calculation, characteristic information determination and characteristic category categorization relating to the first embodiment.

FIG. 17 illustrates another example of user operation and content display relating to the first embodiment.

FIG. 18 illustrates an example of user operation and content display relating to a modified example of the first embodiment.

FIG. 19 is a flowchart illustrating operations of attribute information priority calculation, characteristic information determination and characteristic category categorization relating to a modified example of the first embodiment.

FIG. 20 is a flowchart illustrating an overview of operations relating to a modified example of the first embodiment.

FIGS. 21A and 21B illustrate examples of user operation and content display relating to a modified example of the first embodiment.

FIG. 22 is a flowchart illustrating operations of characteristic information determination and characteristic category categorization relating to a modified example of the first embodiment.

FIG. 23 is a block diagram illustrating a content display processing system relating to a second embodiment.

FIG. 24 illustrates an example of attribute information level relationship setting relating to the second embodiment.

FIG. 25 illustrates another example of attribute information level setting relating to the second embodiment.

FIG. 26 is a flowchart illustrating an overview of operations relating to the second embodiment.

FIG. 27 is a flowchart illustrating operations of attribute information acquisition, attribute information reliability setting and attribute information level relationship setting relating to the second embodiment.

FIG. 28 illustrates an example of user operation and content display relating to the second embodiment.

FIG. 29 is a flowchart illustrating operations of characteristic information determination and characteristic category categorization relating to the second embodiment.

### DESCRIPTION OF EMBODIMENTS

(Background Leading to Invention)

In a typical example of an art for content display processing, pieces of content are arranged based on information such as a capture time, a capture location and a tag input by a user, such as an event name. The pieces of content are displayed in a manner such that the user can browse the pieces of content in terms of categories into which the pieces of content are arranged by performing operations such as scrolling.

Unfortunately, in an art for display processing such as described above, the pieces of content can only be arranged on fixed arrangement axes corresponding to the time, location and tag. Consequently, preferences of the user and matter included in the pieces of content are not reflected in arrangement of the pieces of content, and thus provision may not be possible of a content display method which displays the pieces of content in a manner such as to be easily viewable and searchable by the user.

In consideration of the above, in the present invention the inventor achieved a content display processing device which based on pieces of attribute information, acquirable from pieces of content as metadata, arranges and displays the pieces of content while taking into account reliabilities and trends of the pieces of attribute information, usage trends of the user and the like. The following explains embodiments of the present invention with reference to the drawings.

### First Embodiment

A first embodiment relates to a content display processing device which receives a user instruction relating to content display, and based on pieces of attribute information of a plurality of pieces of content, performs processing to display pieces of display processing target content among the pieces of content after arrangement or expansion thereof. In the first embodiment, “arrangement” refers to categorizing a plurality of pieces of content into one or more categories. “Expansion” refers to widening extent of a display processing target from one piece of content to a plurality of pieces of content related to the one piece of content. The following explains configuration and operation of the content display processing device relating to the first embodiment with reference to the drawings.

(Configuration)

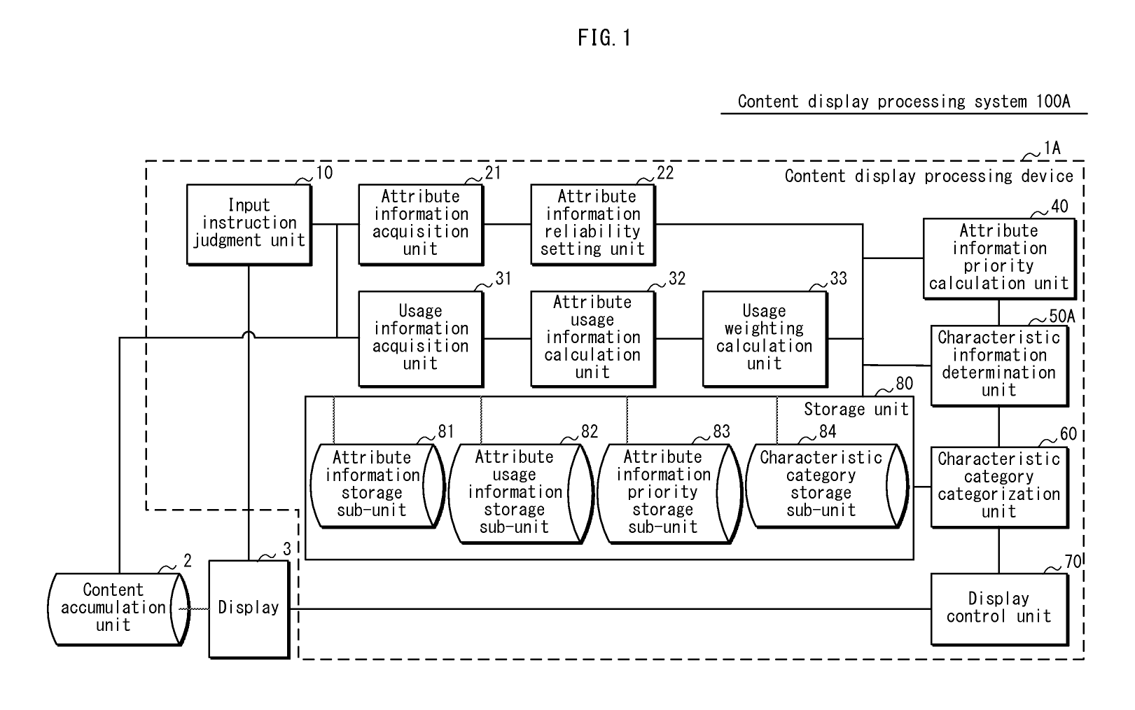

FIG. 1 is a block diagram illustrating a content display system 100A relating to the first embodiment.

The content display system 100A includes a content display processing device 1A, a content accumulation unit 2 and a display 3.

The content accumulation unit 2 has a function of accumulating pieces of content possessed by a user. The content accumulation unit 2 accumulates pieces of content such photographs, videos, audio and text, which are either captured by the user or acquired by the user, for example via the Internet. The content accumulation unit 2 is configured by a storage device, for example a semiconductor memory or a high-capacity media disk, such as an HDD (Hard Disk Drive) or a DVD (Digital Versatile Disk).

The display 3 is provided internally with a touch panel function, and may for example be a resistive film type touch panel. Through internal provision of the touch panel function in the display 3, the content display processing device 1A is able to receive an input operation performed on the touch panel such as a press, scroll, drag and drop, pinch-in or pinch-out.

The content display processing device 1A receives a user instruction relating to content display and determines one or more pieces of characteristic information from among pieces of attribute information, which are acquired from each of the pieces of display processing target content. Each of the pieces of characteristic information indicates an attribute which is characteristic of the pieces of display processing target content. Subsequently, the content display processing device 1A categorizes the pieces of display processing target content into characteristic categories corresponding one-to-one to the pieces of characteristic information which are determined, and causes the display 3 to display the pieces of display processing target content. The following explains functional configuration of the content display processing device 1A.

As illustrated in FIG. 1, the content display processing device 1A includes an input instruction judgment unit 10, an attribute information acquisition unit 21, an attribute information reliability setting unit 22, a usage information acquisition unit 31, an attribute usage information calculation unit 32, a usage weighting calculation unit 33, an attribute information priority calculation unit 40, a characteristic information determination unit 50A, a characteristic category categorization unit 60, a display control unit 70 and a storage unit 80. The storage unit 80 includes an attribute information storage sub-unit 81, an attribute usage information storage sub-unit 82, an attribute information priority storage sub-unit 83 and a characteristic category storage sub-unit 84.

The input instruction judgment unit 10, based on an input signal from the display 3 which is a user instruction relating to content display, judges an objective of content display processing and one or more pieces of display processing target content. By linking in advance of input operations by a user to objectives of content display processing and pieces of display processing target content, the input instruction judgment unit 10 is able to judge various instructions from the user relating to content display.

The attribute information acquisition unit 21 acquires from the pieces of content accumulated in the content accumulation unit 2, pieces of attribute information which are each attached to one or more of the pieces of content.

Herein, “attribute information” refers to metadata attached to each of the pieces of content. The metadata is inclusive of device metadata, analysis metadata and usage metadata.

“Device metadata” is metadata attached to each of the pieces of content by a device acquiring the piece of content, and for example may be EXIF (Exchangeable Image File Format) information, video expansion metadata, CDDB information, or music metadata such as ID3.

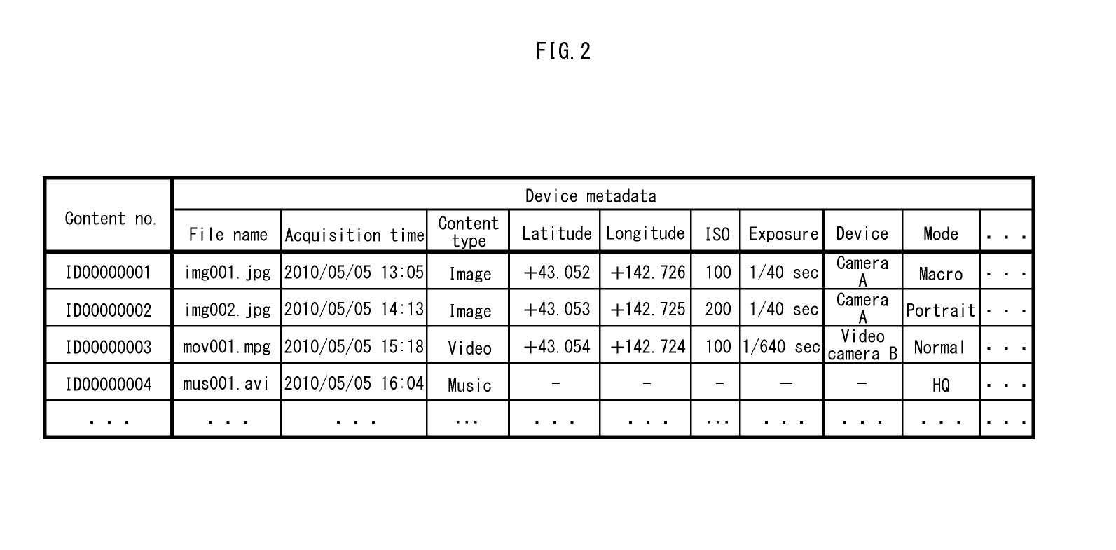

FIG. 2 illustrates an example of device metadata. Device metadata may for example be information relating to a type or an acquisition time of the piece of content. In the case of a piece of content which is a photographic image or a video, device metadata may for example be various types of device parameter or sensor information, such as a capture time, geographical information at capture time such as longitude and latitude information from a GPS (Global Positioning System), ISO (International Organization for Standardization) sensitivity information relating to brightness adjustment at capture time, exposure length information relating to appropriate brightness adjustment, capture device type, capture mode information or the like. In the case of a piece of content which is music, device metadata may for example be sound quality information or music genre information.

“Analysis metadata” refers to metadata acquired by various methods of content analysis.

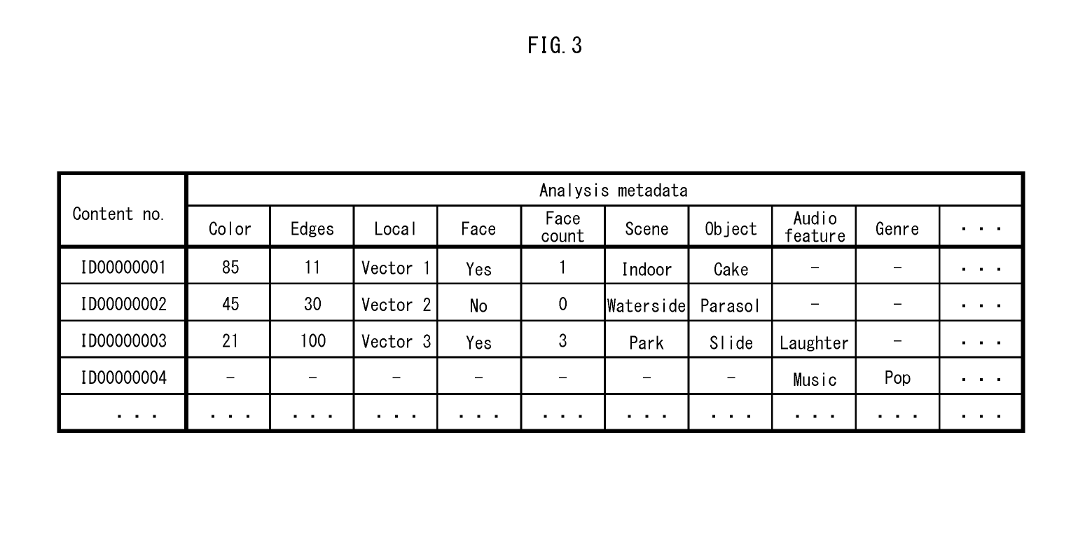

FIG. 3 illustrates an example of analysis metadata.

In the case of a piece of content which is a photographic image, analysis metadata may for example be color information, texture information such as edges, local information indicating a feature point in the image, face information detected using a face detection technique, scene information relating to a background of the image detected using a scene detection technique, or object information relating to an object detected in the image using an object detection technique. The following explains the various types of information listed above.

Color information may be calculated by various methods, for example by calculating RGB (Red Green Blue color model) color values as statistical values in the image, by calculating hue information converted to an HSV (Hue Saturation Value color model) or YUV (a color model that describes color information in terms of its brightness [luminance, y] and color [chrominance, U and V]) color space, or by calculating statistical amount information in the form of a color histogram, color moment or the like.

Texture information may be acquired using a method which calculates as statistical values in the image for each angle at predetermined intervals, edge features detected as line fragments in the image.

Local information indicating a feature point in the image is detected as a high dimension feature amount such as SIFT (Scale Invariant Feature Transform), SURF (Speeded Up Robust Features) or HOG (Histogram of Oriented Gradients), through detection of shapes of objects. Using the high dimension feature amount, identical images can be detected or a degree of similarity between images can be judged.

Face information can for example be acquired as information indicating presence or absence of a face, a face count or face size. Instead of face information, person information relating to a person appearing in the image can be acquired using a person detection technique. The person information may for example be color or shape of clothing with regards to the person to whom the person information pertains.

Scene information can be acquired using a method for calculating region information using a saliency map or a depth map. The method for calculating region information can also be used to acquire information relating to a specific subject in the image.

Object information can be detected using an image recognition technique such as generic object recognition. An object appearing in the image, such as a cat, dog or other pet, or a model of a car, can be detected with a high degree of accuracy.

In the case of a piece of content which is a video, analysis metadata may be analysis information relating to a scene or motion occurring along a time series. In the case of a piece of content which is music, analysis metadata may be audio feature information, genre information, or analysis information for example of a melody in the music.

“Usage metadata” refers to information directly attached to a piece of content by a user and usage history information which is automatically attached to the piece of content in response to use of the piece of content by a user.

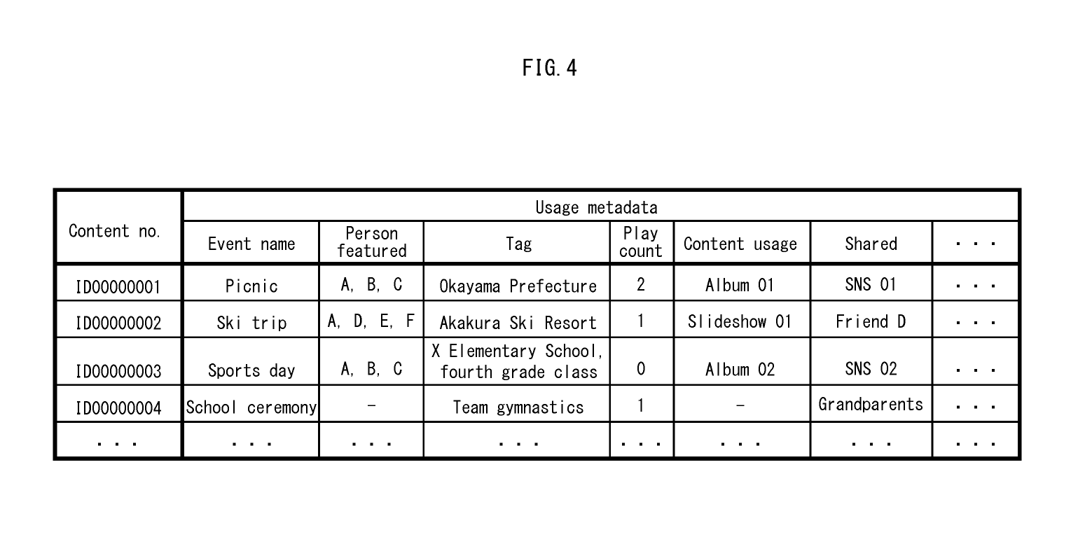

FIG. 4 illustrates an example of usage metadata. Information directly attached to the piece of content by the user may be tagging information such as an event name or person featured in the piece of content. Usage history information may for example be information relating to the number of times the piece of content has been played, sharing information relating to sharing of the piece of content, or processing history information relating to processing of the piece of content. Processing of the piece of content may for example be development of an image, burning to a DVD, or creation of a digital album or slideshow.

The attribute information acquisition unit 21 acquires pieces of attribute information of preset attribute types from among the various types of attribute information described above.

The following continues explanation of FIG. 1.

The attribute information reliability setting unit 22 sets a reliability of each of the pieces of attribute information, acquired by the attribute information acquisition unit 21, in accordance with an attribute type of the piece of attribute information.

Herein, “attribute information reliability” refers to a degree of certainty in relation to each of the pieces of attribute information.

Once the attribute information reliability setting unit 22 has set the reliability of each of the pieces of attribute information, the attribute information reliability setting unit 22 stores in the attribute information storage sub-unit 81, the reliabilities of the pieces of attribute information and information indicating which of the pieces of content each of the pieces of attribute information is acquired from by the attribute information acquisition unit 21.

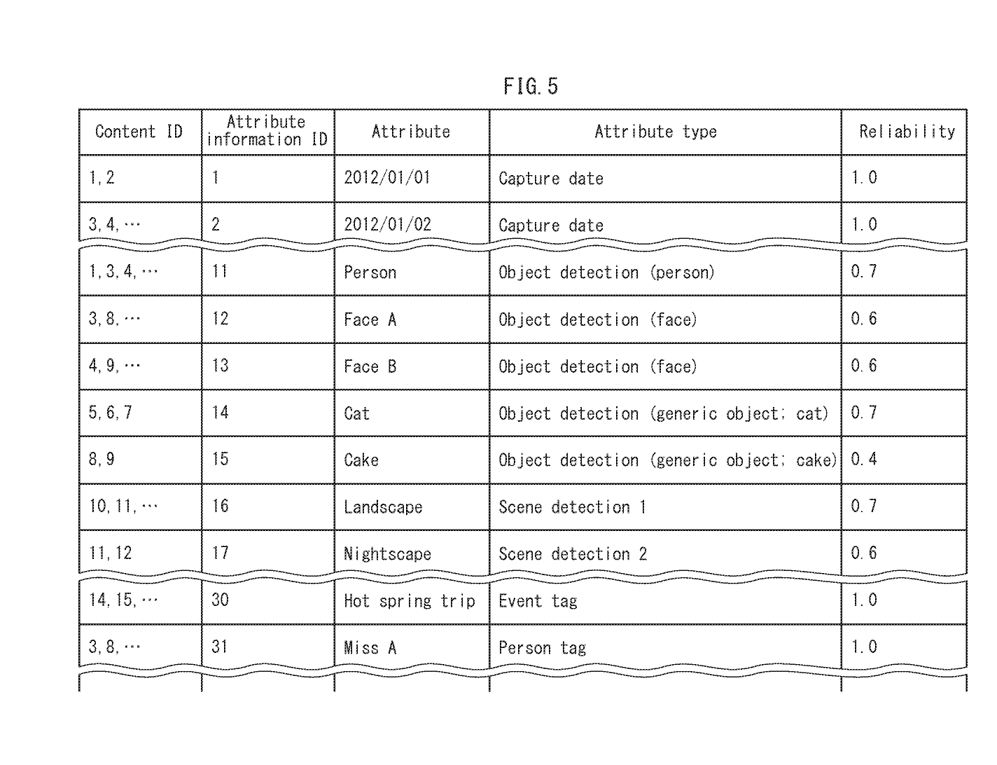

FIG. 5 illustrates an example of data structure of the attribute information storage sub-unit 81. The attribute information storage sub-unit 81 includes headings for “Content ID”, “Attribute information ID”, “Attribute”, “Attribute type” and “Reliability”.

The following uses FIG. 5 to explain an example of attribute information acquisition performed by the attribute information acquisition unit 21 and an example of attribute information reliability setting performed by the attribute information reliability setting unit 22.

The attribute information acquisition unit 21 for example acquires a piece of attribute information “2012/01/01” from images 1 and 2, a piece of attribute information “Cat” from images 5, 6 and 7, and a piece of attribute information “Hot spring trip” from images 14 and 15.

A piece of attribute information “Person” acquired using a person detection technique is for example of an attribute type “Object detection (person)” which has a detection accuracy of 70%, therefore the attribute information reliability setting unit 22 sets reliability of the piece of attribute information “Person” as 0.7. In another example, a piece of attribute information “Cake” acquired using a generic object recognition technique is of an attribute type “Object detection (generic object; cake)” which has a detection accuracy of 40%, therefore the attribute information reliability setting unit 22 sets reliability of the piece of attribute information “Cake” as 0.4. As described above, for a piece of attribute information which is analysis metadata, reliability of the piece of attribute information is set high if detection accuracy of the piece of attribute information is high and reliability of the piece of attribute information is set low if detection accuracy of the piece of attribute information is low. In another example, the piece of attribute information “2012/01/01” of an attribute type “Capture date” is attached by a capture device, and therefore is information which is certain. Consequently, the attribute information reliability setting unit 22 sets reliability of the piece of attribute information “2012/01/01” as 1.0. In a further example, the attribute information “Hot spring trip” of an attribute type “Event tag” is attached directly by the user, and therefore is information which is certain. Consequently, the attribute information reliability setting unit 22 sets reliability of the piece of attribute information “Hot spring trip” as 1.0. As described above, when a piece of attribute information is device metadata or usage metadata, the piece of attribute information is information which is certain, and therefore reliability of the piece of attribute information is set as 1.0.

The following continues explanation of FIG. 1.

The usage information acquisition unit 31 acquires one or more pieces of usage information from each of the pieces of content accumulated in the content accumulation unit 2. Each of the pieces of usage information is attached to the piece of content and relates to usage of the piece of content by the user.

Herein, “usage information” refers to usage metadata such as a display count, a print count, album or other processing information, or SNS (Social Networking Service) sharing information.

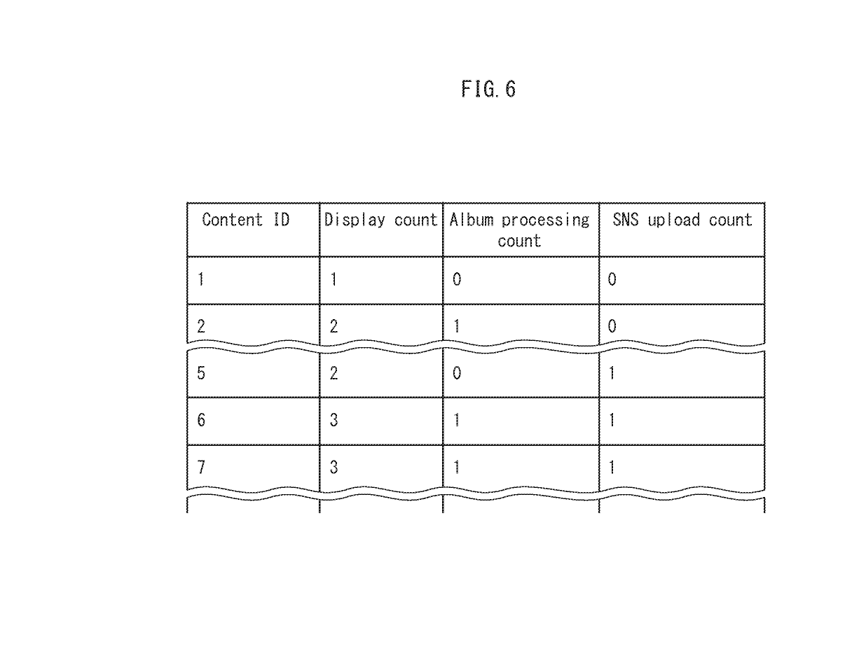

FIG. 6 illustrates an example of pieces of usage information which are acquired by the usage information acquisition unit 31 with regards to each of the pieces of content. For example, the usage information acquisition unit 31 acquires a display count of 1, an album processing count of 0, and an SNS upload count of 0 as pieces of usage information of image 1. In another example, the usage information acquisition unit 31 acquires a display count of 3, an album processing count of 1, and an SNS upload count of 1 as pieces of usage information of image 6.

The attribute usage information calculation unit 32 calculates one or more pieces of attribute usage information for each of the pieces of attribute information. The pieces of attribute usage information are calculated based on the pieces of usage information of the pieces of content acquired by the usage information acquisition unit 31 and the information stored in the attribute information storage sub-unit 81 indicating which of the pieces of content each of the pieces of attribute information is acquired from.

Herein, “attribute usage information” of a piece of attribute information refers to pieces of usage information relating to usage by the user of the pieces of content from which the piece of attribute information is acquired. Pieces of attribute usage information of a piece of attribute information may for example be calculated by calculating a sum total of pieces of usage information of the pieces of content from which the piece of attribute information is acquired.

The usage weighting calculation unit 33 calculates a usage weighting for each of the pieces of attribute information, based on the pieces of attribute usage information calculated by the attribute usage information calculation unit 32.

Herein, “usage weighting” refers to a degree of usage by the user with regards to each of the pieces of attribute information expressed as a weighting value.

The usage weighting calculation unit 33 stores in the attribute usage information storage sub-unit 82, the usage weighting calculated for each of the pieces of attribute information and the pieces of attribute usage information of each of the pieces of attribute information used in calculation of the usage weightings.

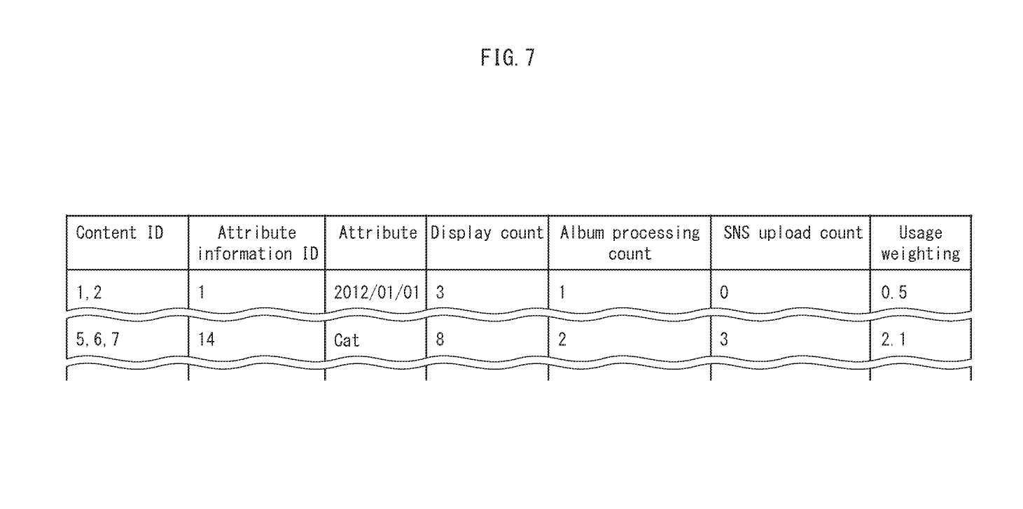

FIG. 7 illustrates an example of data structure of the attribute usage information storage sub-unit 82. The attribute usage information storage sub-unit 82 includes headings for “Content ID”, “Attribute information ID”, “Attribute”, “Display count”, “Album processing count”, “SNS upload count” and “Usage weighting”.

The following explains, with reference to FIGS. 5, 6 and 7, a calculation method of pieces of attribute usage information for each of the pieces of attribute information performed by the attribute usage information calculation unit 32.

FIG. 5 illustrates that the piece of attribute information “2012/01/01” is acquired from images 1 and 2. Consequently, the attribute usage information calculation unit 32 calculates pieces of attribute usage information for the piece of attribute information “2012/01/01” by calculating sum totals of pieces of usage information of images 1 and 2. More specifically, the attribute usage information calculation unit 32 calculates a display count of 3 (=display count of image 1+display count of image 2=1+2), an album processing count of 1 (=0+1), and an SNS upload count of 0 (=0+0) as pieces of attribute usage information of the piece of attribute information “2012/01/01”. In another example, the piece of attribute information “Cat” is acquired from images 5, 6 and 7. Consequently, the attribute usage information calculation unit 32 calculates pieces of attribute usage information of the piece of attribute information “Cat” by calculating sum totals of pieces of usage information of images 5, 6 and 7. More specifically, the attribute usage information calculation unit 32 calculates a display count of 8 (=display count of image 5+display count of image 6+display count of image 7=2+2+3), an album processing count of 2 (=0+1+1), and an SNS upload count of 3 (=1+1+1) as pieces of attribute usage information of the piece of attribute information “Cat”.

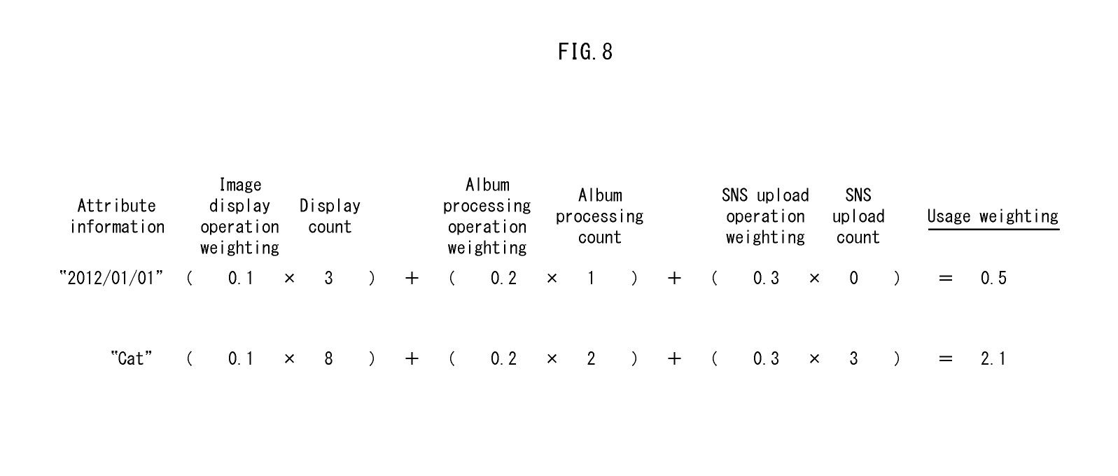

The following explains, with reference to FIG. 8, a calculation method used by the usage weighting calculation unit 33 for calculating a usage weighting of each of the pieces of attribute information.

In the usage weighting calculation unit 33, operation weightings are set in advance such as an operation weighting of 0.1 for a display operation, 0.2 for an album processing operation and 0.3 for an SNS upload operation. For example, suppose a display count of 3, an album processing count of 1 and an SNS upload count of 0 are pieces of attribute usage information for the piece of attribute information “2012/01/01”. In the above situation the usage weighting calculation unit 33 calculates a usage weighting of 0.5 (=0.1×3+0.2×1+0.3×0) for the piece of attribute information “2012/01/01”. In another example, suppose a display count of 8, an album processing count of 2 and an SNS upload count of 3 are pieces of attribute usage information for the piece of attribute information “Cat”. In the above situation the usage weighting calculation unit 33 calculates a usage weighting of 2.1 (=0.1×8+0.2×2+0.3×3) for the piece of attribute information “Cat”. As described above, the usage weighting calculation unit 33 calculates a usage weighting for each of the pieces of attribute information by first calculating a product of an operation weighting and an operation count of each user operation relating to the piece of attribute information and then calculating a sum total of the products of all user operations relating to the piece of attribute information.

Operation weightings for the display operation, the album processing operation and the SNS upload operation may be set in advance, for example based on a degree of importance which is generally associated with the operation. For example, an operation such as the display operation, which is performed for each of the pieces of content with high frequency, is an operation which is performed without requirement of significant effort by the user, and therefore may be considered to be an operation for which a degree of importance is not particularly high. Consequently, an operation weighting of an operation such as described above may be set as a low value. On the other hand, an operation such as the album processing operation or the SNS upload operation, which is performed for each of the pieces of content with low frequency, is an operation requiring more effort by the user than compared to the display operation described above, and therefore may be considered to be an operation for which a degree of importance is relatively high. Consequently, an operation weighting of an operation such as described above may be set as a high value.

The following continues explanation of FIG. 1.

The attribute information priority calculation unit 40 calculates a priority of each of the pieces of attribute information based on the reliability of the piece of attribute information set by the attribute information reliability setting unit 22 and the usage weighting of the piece of attribute information calculated by the usage weighting calculation unit 33.

Herein, “attribute information priority” refers to a value expressing a degree of priority given to a piece of attribute information when, as described further below, the characteristic information determination unit 50A determines pieces of characteristic information.

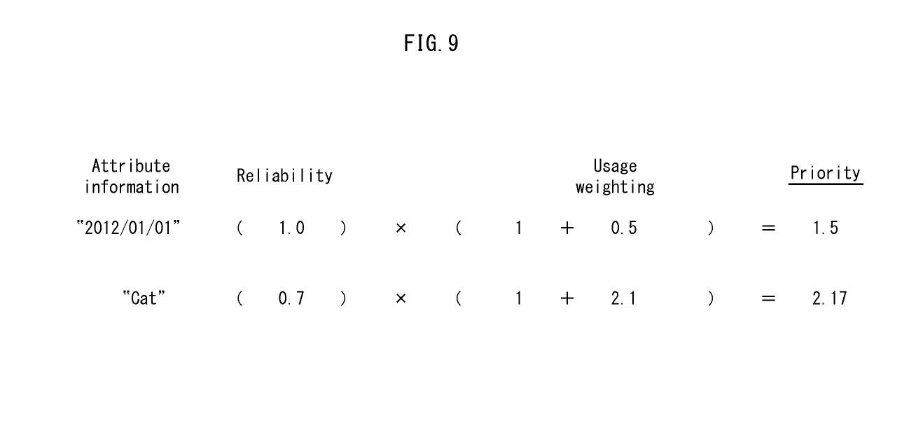

The following explains, with reference to FIG. 9, a method used by the attribute information priority calculation unit 40 for calculating the priority of each of the pieces of attribute information.

For example, suppose the piece of attribute information “2012/01/01” has a reliability of 1.0 and a usage weighting of 0.5. In the above situation, the attribute information priority calculation unit 40 calculates a priority of 1.5 (=reliability×[1+usage weighting]=1.0×1.5) for the piece of attribute information “2012/01/01”. In another example, suppose the piece of attribute information “Cat” has a reliability of 0.7 and a usage weighting of 2.1. In the above situation, the attribute information priority calculation unit 40 calculates a priority of 2.17 (=reliability×[1+usage weighting]=0.7×[1+2.1]=0.7×3.1) for the piece of attribute information “Cat”. In the above examples, the reliability of the piece of attribute information “Cat” is lower than the reliability of the piece of attribute information “2012/01/01”. However, the usage weighting of the piece of attribute information “Cat” is higher than the usage weighting of the piece of attribute information “2012/01/01”, and consequently in the above example the priority of the piece of attribute information “Cat” is calculated to be a higher value than the priority of the piece of attribute information “2012/01/01”.

The usage weighting of each of the pieces of attribute information is calculated based on the pieces of attribute usage information thereof. The priority of each of the pieces of attribute information is calculated based on the usage weighting calculated for the piece of attribute information. Therefore, the priorities of the pieces of attribute information reflect preferences of the user.

The priorities of the pieces of attribute information calculated by the attribute information priority calculation unit 40 are stored in the attribute information priority storage sub-unit 83 after being used by the characteristic information determination unit 50A in determination of pieces of characteristic information as explained further below.

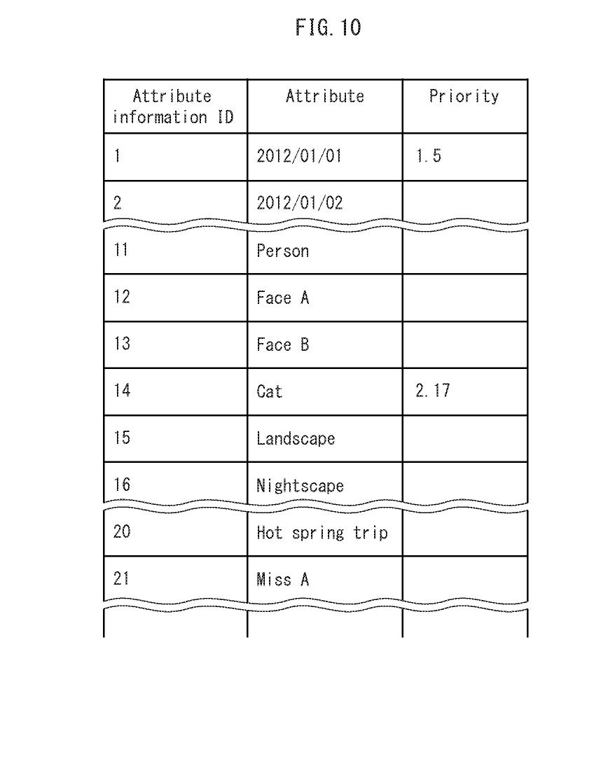

FIG. 10 illustrates an example of data structure of the attribute information priority storage sub-unit 83. The attribute information priority storage sub-unit 83 includes headings for “Attribute information ID”, “Attribute” and “Priority”.

The following continues explanation of FIG. 1.

The characteristic information determination unit 50A determines one or more pieces of characteristic information from among the pieces of attribute information acquired from the pieces of display processing target content. The pieces of characteristic information are determined based on the priorities of the pieces of attribute information calculated by the attribute information priority calculation unit 40, the information stored in the attribute information storage sub-unit 81 indicating which of the pieces of content each of the pieces of attribute information is acquired from, and characteristic category categorization information of each of the pieces of content stored in the characteristic category storage sub-unit 84, which is explained further below.

Herein, each piece of “characteristic information” is information indicating an attribute which is characteristic of the pieces of display processing target content. Each of the pieces of characteristic information is used as a display heading when displaying the pieces of display processing target content. Among the pieces of attribute information acquired from the pieces of display processing target content, pieces of attribute information having high priorities calculated by the attribute information priority calculation unit 40 are prioritized when determining the pieces of characteristic information. Consequently, pieces of attribute information having high reliabilities and high frequencies of usage are prioritized when determining the pieces of characteristic information.

A method used by the characteristic information determination unit 50A to determine the pieces of characteristic information is explained in detail further below in sections Operation 1 and Operation 2.

The characteristic category categorization unit 60 categorizes the pieces of display processing target content into one or more characteristic categories. The characteristic category categorization unit 60 categorizes the pieces of display processing target content based on the one or more pieces of characteristic information determined by the characteristic information determination unit 50A, the information stored in the attribute information storage sub-unit 81 indicating which of the pieces of content each of the pieces of attribute information is acquired from, and characteristic category categorization information of each of the pieces of content stored in the characteristic category storage sub-unit 84 which is explained further below.

After performing categorization processing for the pieces of display processing target content, the characteristic category categorization unit 60 stores in the characteristic category storage sub-unit 84, characteristic category categorization information relating to the categorization processing.

Herein, “characteristic category categorization information” refers to information indicating which characteristic category each of the pieces of display processing target content is categorized into.

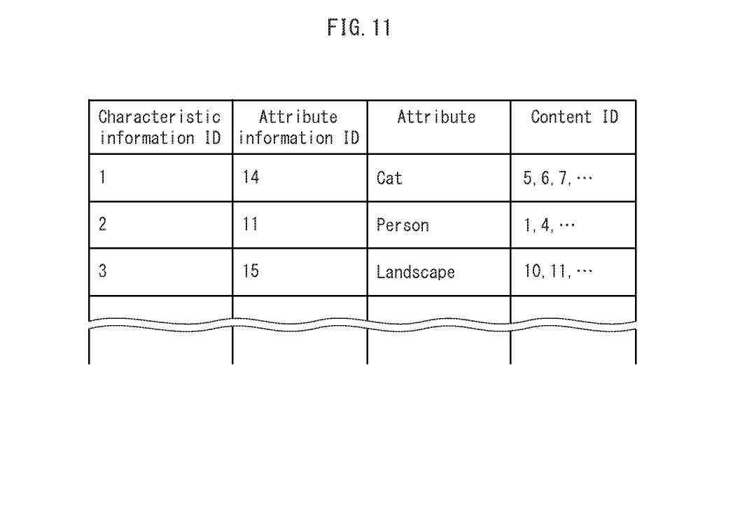

FIG. 11 illustrates an example of data structure of the characteristic category storage sub-unit 84. The characteristic category storage sub-unit 84 includes headings for “Characteristic information ID”, “Attribute information ID”, “Attribute” and “Content ID”.

A method used by the characteristic category categorization unit 60 for categorizing the pieces of display processing target content into characteristic categories is explained in detail further below in Operation 1 and Operation 2.

Based on the characteristic category categorization information stored in the characteristic category storage sub-unit 84, the display control unit 70 controls the display 3 to display the pieces of display processing target content in a manner such that the user can understand which characteristic category each of the pieces of display processing target content is categorized into.

The input instruction judgment unit 10, the attribute information acquisition unit 21, the attribute information reliability setting unit 22, the usage information acquisition unit 31, the attribute usage information calculation unit 32, the usage weighting calculation unit 33, the attribute information priority calculation unit 40, the characteristic information determination unit 50A, the characteristic category categorization unit 60 and the display control unit 70 may for example be configured by a CPU (Central Processing Unit) executing a control program stored in a ROM (Read Only Memory).

The storage unit 80 has a function of storing the various types of information described above. The storage unit 80 is for example a storage device such as a semiconductor memory, or a high-capacity media disk such as an HDD or a DVD.

(Operation 1)

The following explains operation of the content display processing device 1A relating to the first embodiment. As a specific example, an example is given in which arrangement and display processing is performed on a plurality of images.

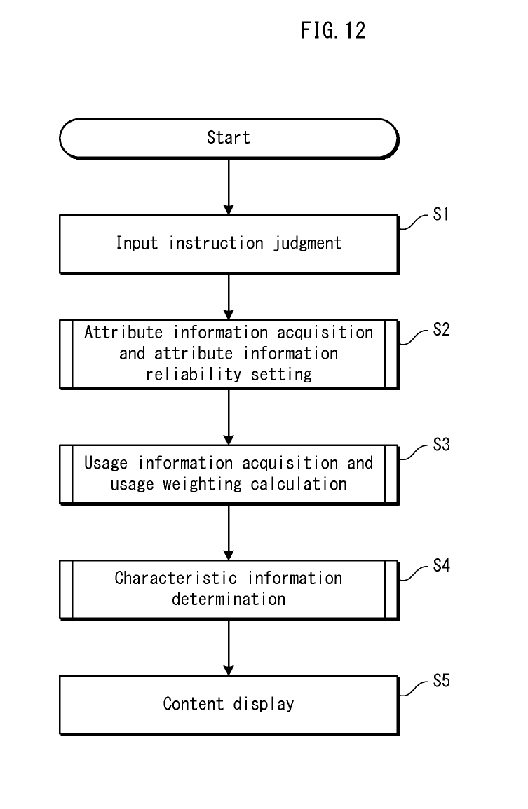

FIG. 12 is a flowchart illustrating processing order of operations performed by the content display processing device 1A. The content display processing device 1A performs processing for input instruction judgment (S1), attribute information acquisition and attribute information reliability setting (S2), usage information acquisition and usage weighting calculation (S3), characteristic information determination (S4) and content display (S5) in respective order.

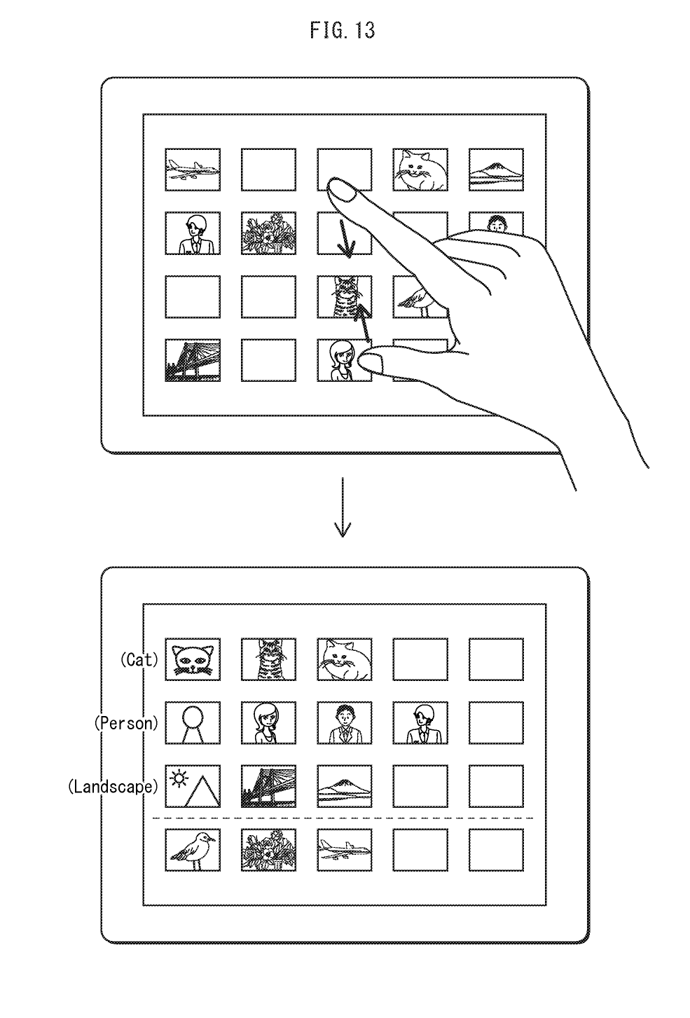

First, when an input operation is performed by a user, the display 3 outputs an input signal corresponding to the input operation to the input instruction judgment unit 10. For example, the input operation may be a pinch-in operation performed centrally or approximately centrally on the display 3 which is displaying all images possessed by the user in list format (refer to an upper section of FIG. 13).

In Step S1, the input instruction judgment unit 10 judges that, due to the input operation being a pinch-in operation, an objective of content display processing is image arrangement. Furthermore, the input instruction judgment unit 10 judges that, due to the input operation being an operation performed centrally or approximately centrally on the display 3, all images possessed by the user, which are displayed on the display 3 when the input operation is performed, are pieces of display processing target content.

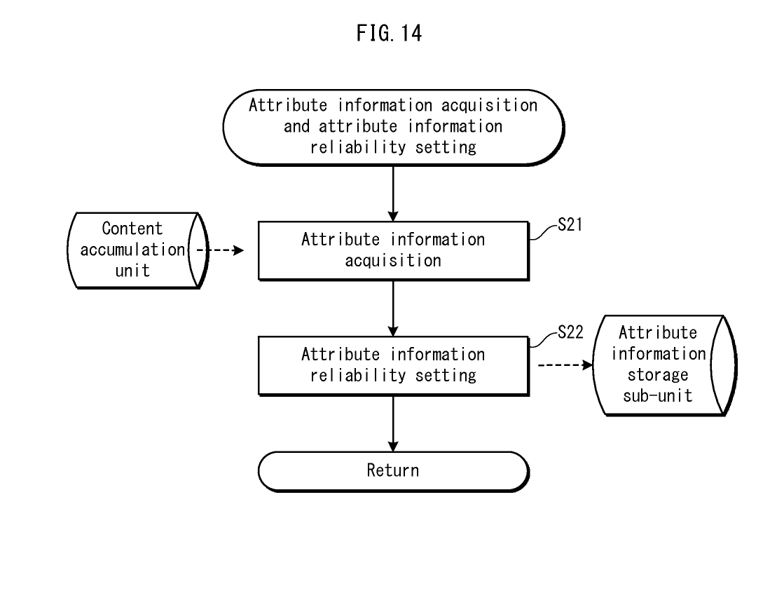

FIG. 14 is a flowchart illustrating processing order of Step S2 (FIG. 12: Attribute information acquisition and attribute information reliability setting) which follows Step S1.

The attribute information acquisition unit 21 acquires pieces of attribute information of preset attribute types from each image accumulated in the content accumulation unit 2 (Step S21).

Next, the attribute information reliability setting unit 22 sets a reliability of each of the pieces of attribute information acquired in Step S21, in accordance with the attribute type of the piece of attribute information. The attribute information reliability setting unit 22 also stores in the attribute information storage sub-unit 81, the reliabilities of the pieces of attribute information set in Step S22 and information indicating which of the images each of the pieces of attribute information is acquired from (Step S22).

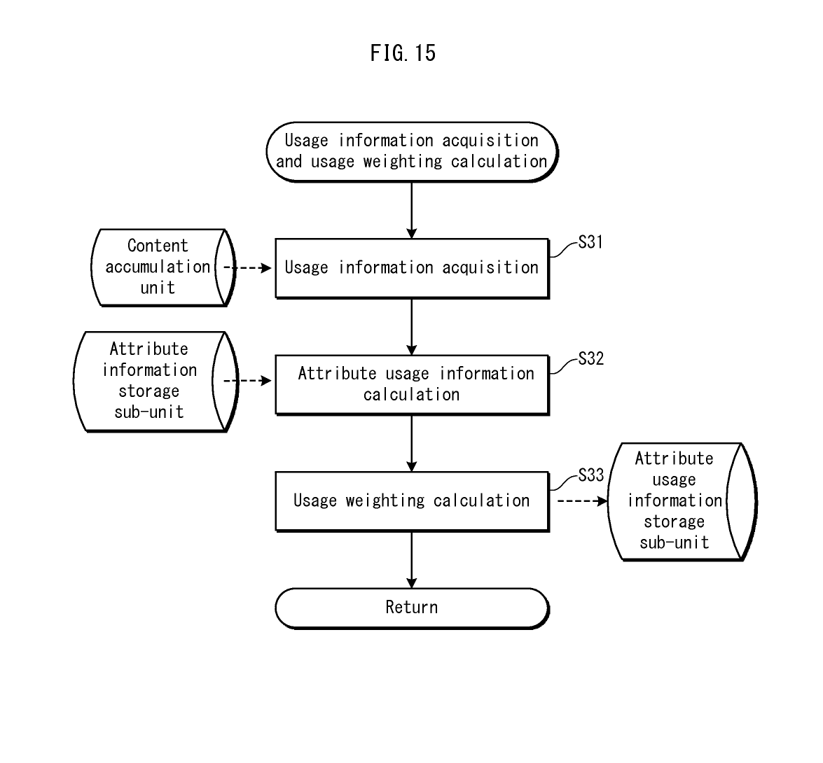

FIG. 15 is a flowchart illustrating processing order of Step S3 (FIG. 12: Usage information acquisition and usage weighting calculation) which follows Step S2.

The usage information acquisition unit 31 acquires pieces of usage information, relating to usage by the user, for each of the images accumulated in the content accumulation unit 2 (Step S31).

Next, the attribute usage information calculation unit 32 calculates pieces of attribute usage information for each of the pieces of attribute information based on the pieces of usage information of the images acquired in Step S31, and the information indicating which of the images each of the pieces of attribute information stored in the attribute information storage sub-unit 81 is acquired from (Step S32).

Next, the usage weighting calculation unit 33 calculates a usage weighting of each of the pieces of attribute information based on the pieces of attribute usage information calculated for the piece of attribute information in Step S32. The usage weighting calculation unit 33 also stores in the attribute usage information storage sub-unit 82, the usage weightings which are calculated and the pieces of attribute usage information which are used in calculation of the usage weightings (Step S33).

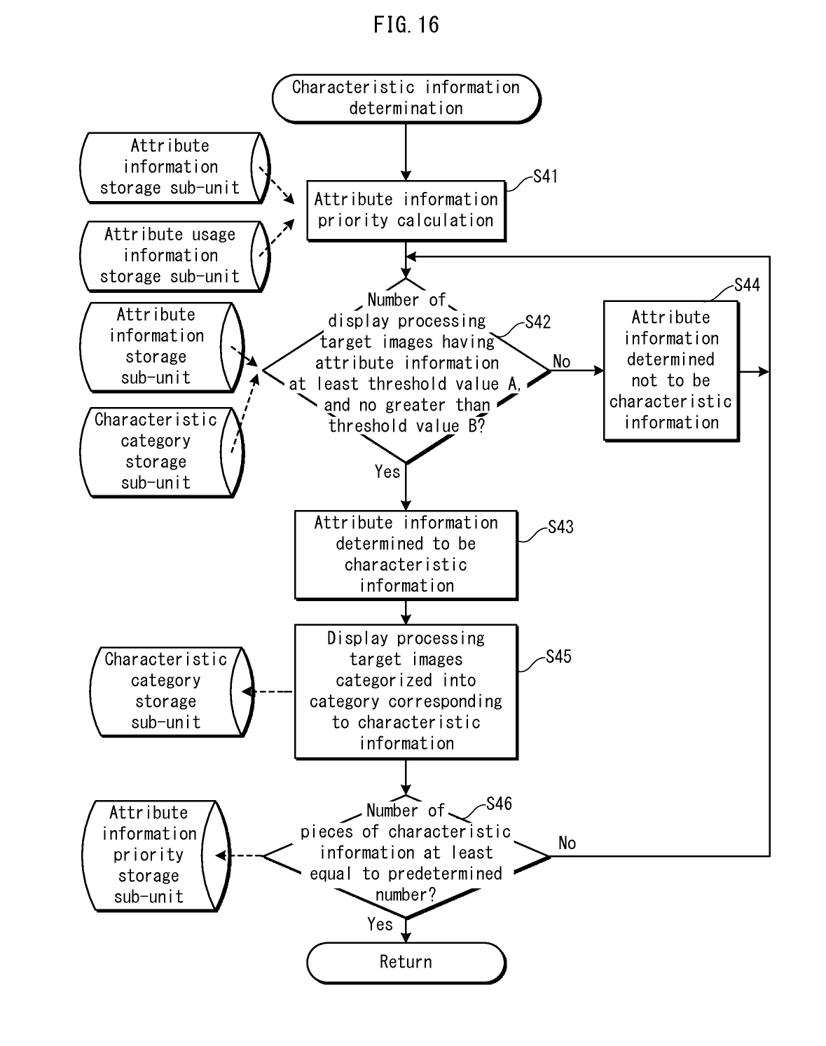

FIG. 16 is a flowchart illustrating processing order in Step S4 (FIG. 12: Characteristic information determination) which follows Step S3.

The attribute information priority calculation unit 40 calculates a priority of each of the pieces of attribute information based on the reliability of the piece of attribute information stored in the attribute information storage sub-unit 81 and the usage weighting of the piece of attribute information stored in the attribute usage information storage sub-unit 82 (Step S41).

Next, the characteristic information determination unit 50A judges in order, starting from a piece of attribute information having a highest priority among the priorities calculated in Step S41, whether or not the piece of attribute information should be used as a piece of characteristic information (Step S42). The characteristic information determination unit 50A performs the above judgment based on the information indicating which of the images each of the pieces of attribute information stored in the attribute information storage sub-unit 81 is acquired from, and information stored in the characteristic category storage sub-unit 84 indicating which characteristic category each of the images is categorized into. More specifically, in Step S42 when the number of images among the display processing target images which have the piece of attribute information and which also are not already categorized into a characteristic category in Step S45 (explained further below), is judged to be at least a threshold value A and no greater than a threshold value B (Step S42: Yes), the characteristic information determination unit 50A determines the piece of attribute information to be a piece of characteristic information (Step S43). If the number of images is judged to be less than the threshold value A or greater than the threshold value B (Step S42: No), the piece of attribute information is determined to not be a piece of characteristic information (Step S44), and judgment processing in Step S42 is performed for a piece of attribute information having a next highest priority.

When a piece of characteristic information is used as a display heading when displaying the display processing target images on the display 3, if the number of images displayed under the display heading is too small, the display processing target images are not displayed in a manner such as to be easily viewable by the user. Therefore, the number of images being at least the threshold value A is used a condition for determining the piece of characteristic information in Step S42. On the other hand, if a large proportion of the display processing target images are displayed under the display heading, the display processing target images cannot be considered to have been sufficiently arranged and are not displayed in a manner such as to be easily viewable by the user. Therefore, the number of images being no greater than the threshold value B is used as a condition for determining the piece of characteristic information in Step S42. The threshold values A and B may be set in advance, for example based on display size and display format to be used when pieces of display processing target content on the display 3. Alternatively, the threshold values A and B may be set by the characteristic information determination unit 50A in accordance with the number of pieces of display processing target content.

Next, the characteristic category categorization unit 60 categorizes images into a characteristic category corresponding to the piece of characteristic information determined in Step S43. The characteristic category categorization unit 60 categorizes images among the display processing target images which are not already categorized into another characteristic category and from which the piece of attribute information determined to be the piece of characteristic information is acquired. The characteristic category categorization unit 60 stores characteristic category categorization information relating to the above categorization in the characteristic category storage sub-unit 84 (Step S45).

Next, when the number of characteristic categories into which the display processing target images are categorized, in other words the number of pieces of characteristic information, reaches a predetermined number (Step S46: Yes), the characteristic information determination unit 50A terminates the processing for characteristic information determination, and stores the priorities of the pieces of attribute information used in the processing for characteristic information determination in the attribute information priority storage sub-unit 83 (Step S47). On the other hand, when the number of pieces of characteristic information has not reached the predetermined number (Step S46: No), the characteristic information determination unit 50A repeats processing from Step S42.

Finally, the display control unit 70 acquires the characteristic category categorization information for the display processing target images, which is stored in the characteristic category storage sub-unit 84. The display control unit 70 controls the display 3 to display the display processing target images in the characteristic categories, using a display format in which arrangement of the display processing target images can be easily understood by the user (Step S5).

FIG. 13 (lower section) illustrates an example of display of the display processing target images in Operation 1. For the example in FIG. 13 (lower section), pieces of attribute information “Cat”, “Person” and “Landscape” are each determined to be a piece of characteristic information in order of highest priority calculated in Step S41, and the display processing target images are arranged and displayed in characteristic categories corresponding one-to-one to the pieces of characteristic information which are determined. By displaying images categorized into the same characteristic category of “Cat”, “Person” or “Landscape” in a horizontal row, the display processing target images are displayed in a manner such that the user can easily understand which characteristic category each of the display processing target images is categorized into. At a far left end of the rows, thumbnails are displayed respectively indicating “Cat”, “Person” and “Landscape”. Images among the display processing target images which are not categorized into any of the characteristic categories of “Cat”, “Person” and “Landscape” are displayed in a bottom row.

The display control unit 70 may change layout used to display the display processing target images in accordance with size of the display 3 or an apparatus in which the display 3 is provided. For example, when the display processing target images cannot be completely displayed on the display 3, a scroll operation may be used to move images on the display 3. Also, if scrolling operations can be performed with respect to each of the characteristic categories, a scroll operation may for example be performed on images displayed in the characteristic category “Cat” (refer to the lower section of FIG. 13). Furthermore, images among the display processing target images displayed in each of the characteristic categories may be rearranged, for example by arranging images displayed in the characteristic category “Cat” in order of most recent acquisition date.

(Operation 2)

In Operation 1 an example is given of operation of the content display processing device 1A in which arrangement and display processing is performed with regards to a plurality of images. In Operation 2 an example is given of performance of expansion and display processing from one image to a plurality of images related to the one image. Basic operation steps of Operation 2 are the same as in Operation 1, therefore the following only explains differences compared to Operation 1.

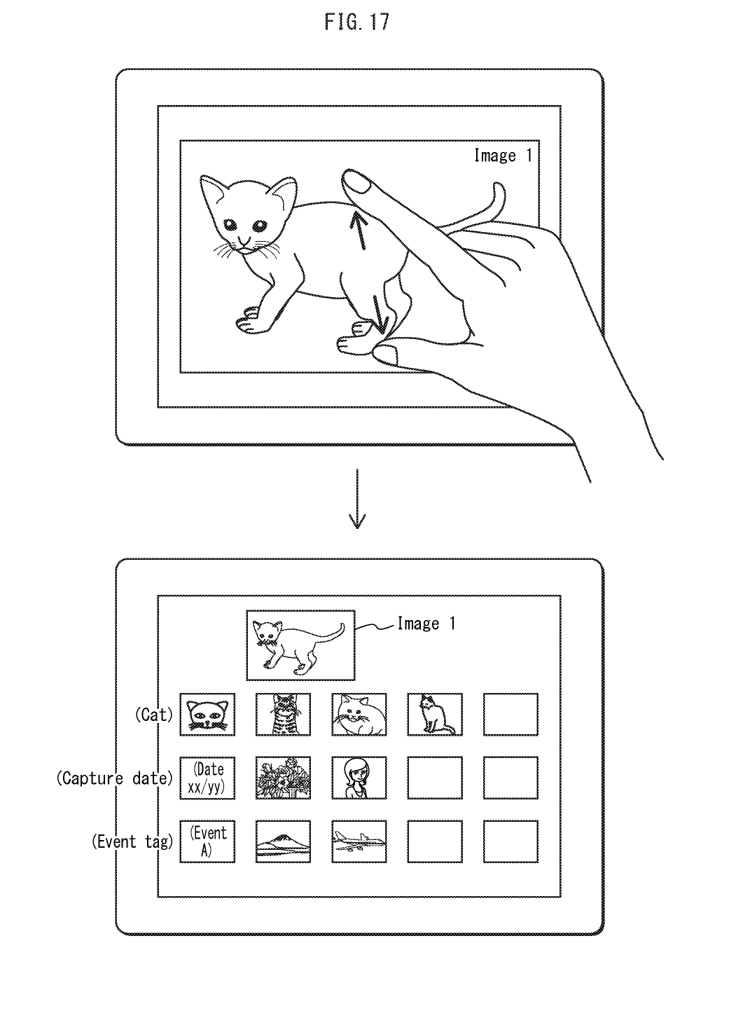

First, an input operation is performed by the user, for example a pinch-out operation with regards to image 1 displayed on the display 3 (refer to an upper section of FIG. 17).

In Step S1 of Operation 1, the input instruction judgment unit 10 judges that the objective of content display processing is image arrangement, and therefore that all possessed images are display processing target images. In Operation 2 the input operation is a pinch-out operation, therefore the input instruction judgment unit 10 judges that the objective of content display processing is expansion to a plurality of images. Furthermore, due to the input operation being performed with regards to image 1, the input instruction judgment unit 10 judges that all images having one or more same pieces of attribute information as image 1 are display processing target images.

The characteristic information determination unit 50A determines one or more pieces of characteristic information from among the pieces of attribute information acquired from the display processing target contents. Therefore, in Step S42 of Operation 2, the characteristic information determination unit 50A determines one or more pieces of characteristic information from among pieces of attribute information acquired from the images having one or more same pieces of attribute information as image 1.

In Step S5 the display control unit 70 controls the display 3 to display the display processing target images categorized into the characteristic categories, using a display format such that the user can easily understand that expansion has been performed from image 1 to the display processing target images.

FIG. 17 (lower section) illustrates an example of display of the display processing target images in Operation 2. In FIG. 17 (lower section) “Cat”, “Date xx/yy” and “Event A” are each determined as a piece of characteristic information in order of highest priority, and the display processing target images, which are related to image 1, are arranged and displayed in characteristic categories corresponding one-to-one to the pieces of characteristic information which are determined.

(Summary)

The content display processing device 1A determines one or more pieces of characteristic information using pieces of attribute information of pieces of content and pieces of usage information of the user with regards to each of the pieces of attribute information. Each of the pieces of characteristic information indicates an attribute which is characteristic of pieces of display processing target content. The content display processing device 1A subsequently categorizes the pieces of display processing target content into characteristic categories corresponding one-to-one to the pieces of characteristic information which are determined, and displays the pieces of display processing target content categorized into the characteristic categories. Therefore, through the content display processing device 1A the pieces of display processing target content can be arranged and displayed in a manner which reflects matter included in the pieces of content and user preferences inferred from usage trends of the pieces of content by the user. The content display processing device 1A determines the pieces of characteristic information based on pieces of attribute information and pieces of usage information acquired not only from the pieces of display processing target content, but also from all pieces of content accumulated in the content accumulation unit 2. Consequently, arrangement and display of the pieces of display processing target content can be performed in a manner such as to reflect user preferences which are inferred based not only on usage trends of the user with regards to the pieces of display processing target content, but also with regards to all of the pieces of content accumulated in the content accumulation unit 2.

### Modified Examples

### Part 1

### Modified Example [1]

In Operation 2 described above, an example is given in which the content display processing device 1A performs expansion and display processing from one image to a plurality of images related to the one image, but the above operation may be modified as described below. Explanation is given of modifications of Operation 2, but explanation is omitted for operation steps which are the same as in Operation 2.

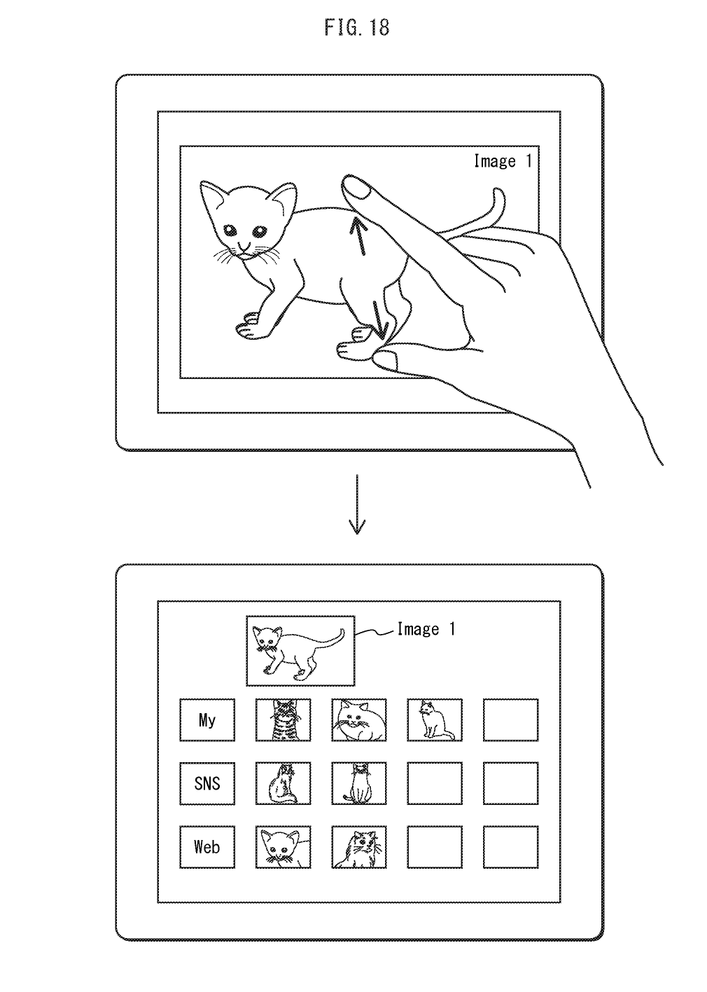

First, in the same way as in Operation 2, a pinch-out operation is for example performed with regards to image 1 displayed on the display 3 (refer to an upper section of FIG. 18).

In Operation 2, the input instruction judgment unit 10 judges that all images having one or more same pieces of attribute information as image 1 are display processing target images (Step S1). In contrast, in modified example [1] the input instruction judgment unit 10 judges that image 1 is an instruction target image for the user, without judging display processing target images (Step S1A).

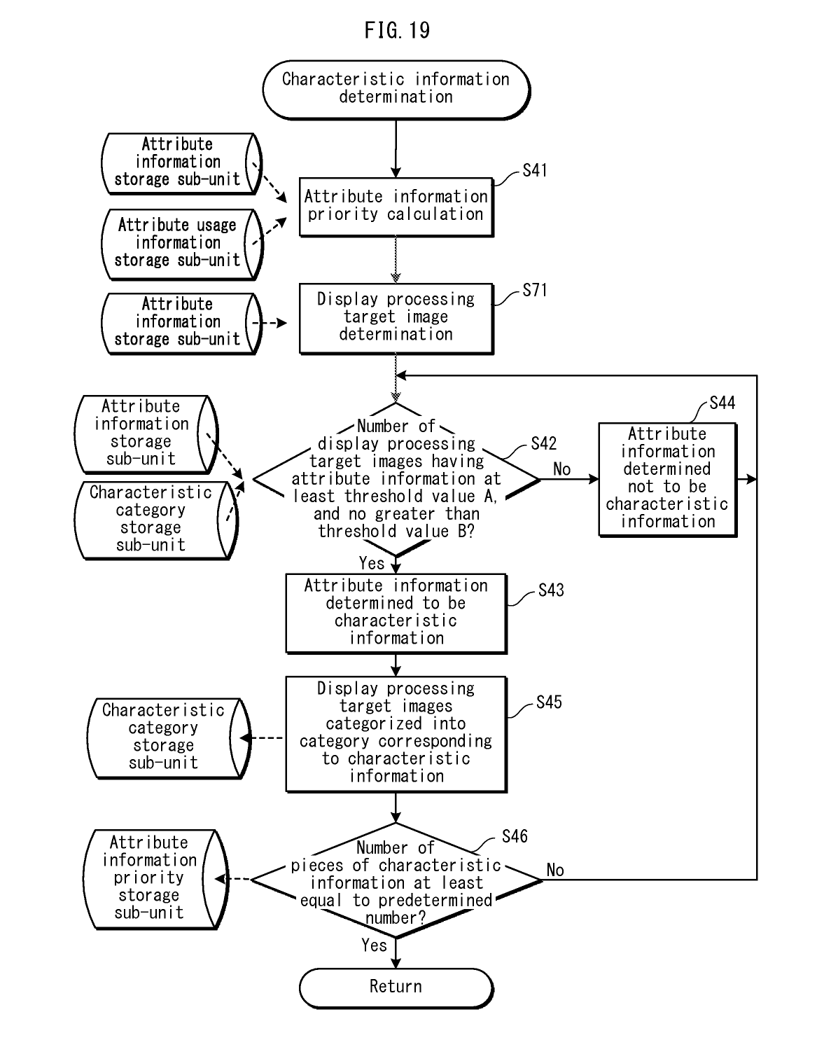

FIG. 19 illustrates a modified flowchart of processing order of characteristic information determination (Step S4) in Operation 2.

First, in Step S41 the attribute information priority calculation unit 40 calculates a priority of each of the pieces of attribute information in the same way as in Operation 2.

Next, in Step S71 the characteristic information determination unit 50A determines that among all pieces of attribute information acquired from image 1, which is the instruction target image, a piece of attribute information with a highest priority calculated in Step S41 is a main piece of attribute information of image 1. The characteristic information determination unit 50A then determines that all images having the main piece of attribute information are display processing target images.

Operation steps in Steps S42-S46 are the same as in Operation 2. However, in Step S42 of modified example [1] the characteristic information determination unit 50A determines for each piece of attribute information acquired from the images having the main piece of attribute information, whether the piece of attribute information is a piece of characteristic information.

FIG. 18 (lower section) illustrates an example of display of the display processing target images in modified example [1]. In FIG. 18 (lower section), a piece of attribute information “Cat” is determined to be a main piece of attribute information of image 1, and images having the piece of attribute information “Cat” are displayed on the display 3 as display processing target images. Thus in modified example [1], when the objective of content display processing is expansion from an instruction target image to a plurality of images, images which are desired by the user are automatically inferred to be images having the main piece of attribute information of the instruction target image. For example, when the main piece of attribute information is “Cat”, images which are desired by the user are inferred to be images from which the piece of attribute information “Cat” is acquired. The images having the main piece of attribute information are determined to be display processing target images and are displayed on the display 3.

In FIG. 18 (lower section), “My”, “SNS” and “Web” are thumbnails respectively representing a piece of attribute information “My data” which indicates that an image is captured by the user, a piece of attribute information “SNS shared data” indicating that an image is shared using an SNS, and a piece of attribute information “WEB download data” which indicates that an image is downloaded from the Internet. The pieces of attribute information “My data”, “SNS shared data” and “WEB download data” each indicate a content acquisition source.

In the above explanation of operation of modified example [1], the characteristic information determination unit 50A determines one or more pieces of characteristic information in the same way as in Operation 2, but alternatively the pieces of characteristic information may be determined from among pieces of attribute information of a certain attribute type which is set in advance. For example, the pieces of characteristic information may be determined in order of highest priority from among pieces of attribute information “My data”, “SNS shared data” and “Download data”, which are pieces of attribute information of an attribute type “Content acquisition source”. Alternatively, in operation of modified example [1], the pieces of characteristic information may be determined from among pieces of attribute information other than the pieces of attribute information indicating a content acquisition source. For example, the pieces of characteristic information may alternatively be determined from among pieces of attribute information relating to capture dates of each piece of content.

### Modified Example [2]

In Operation 1, the content display processing device 1A is explained using a specific example in which arrangement and display processing are performed with regards to a plurality of images, but operation may be modified as described below. In Operation 1 the content display processing device 1A arranges the display processing target images into a predetermined number of characteristic categories, but in modified example [2] the number of characteristic categories is increased upon each user operation when arranging and displaying the display processing target images. Explanation is given of modifications from Operation 1, but explanation is omitted for operation steps which are the same as in Operation 1.

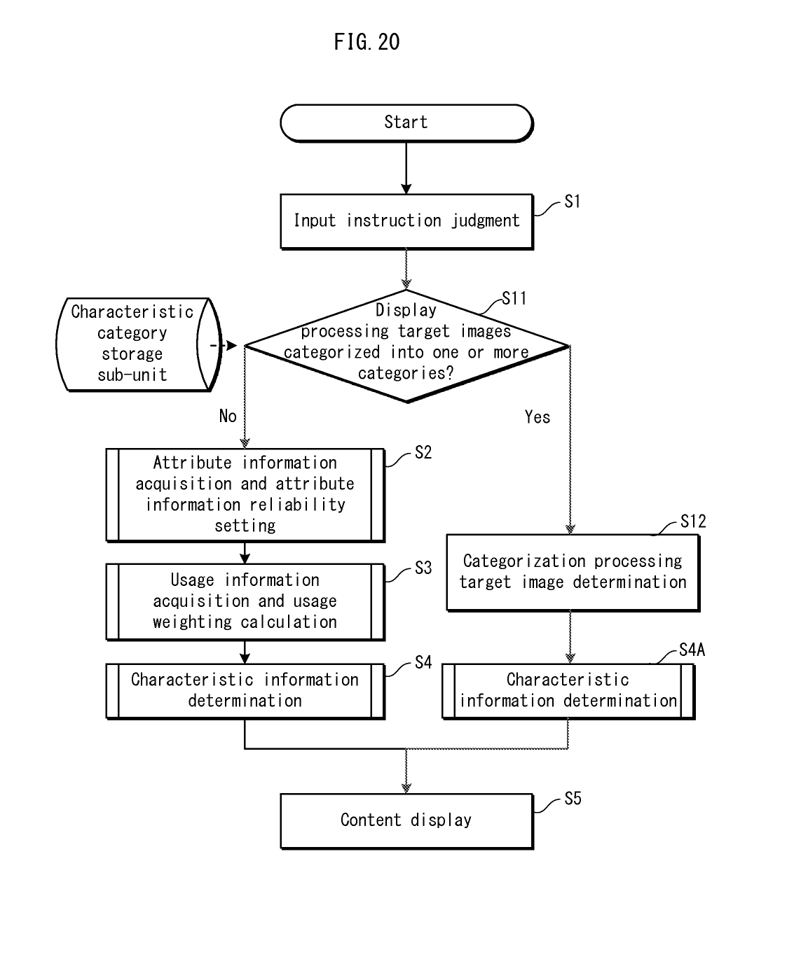

FIG. 20 is a flowchart illustrating processing order of operations performed by the content display processing device 1A in modified example [2].

First, an input operation is performed by a user in the same way as in Operation 1, for example a pinch-in operation in the center or approximately centrally on the display 3, which is displaying all possessed images in list format. In Step S1 input instruction judgment unit 10 judges, in the same way as in Operation 1, that the objective of content display processing is image arrangement, and therefore that all possessed images are display processing target images.

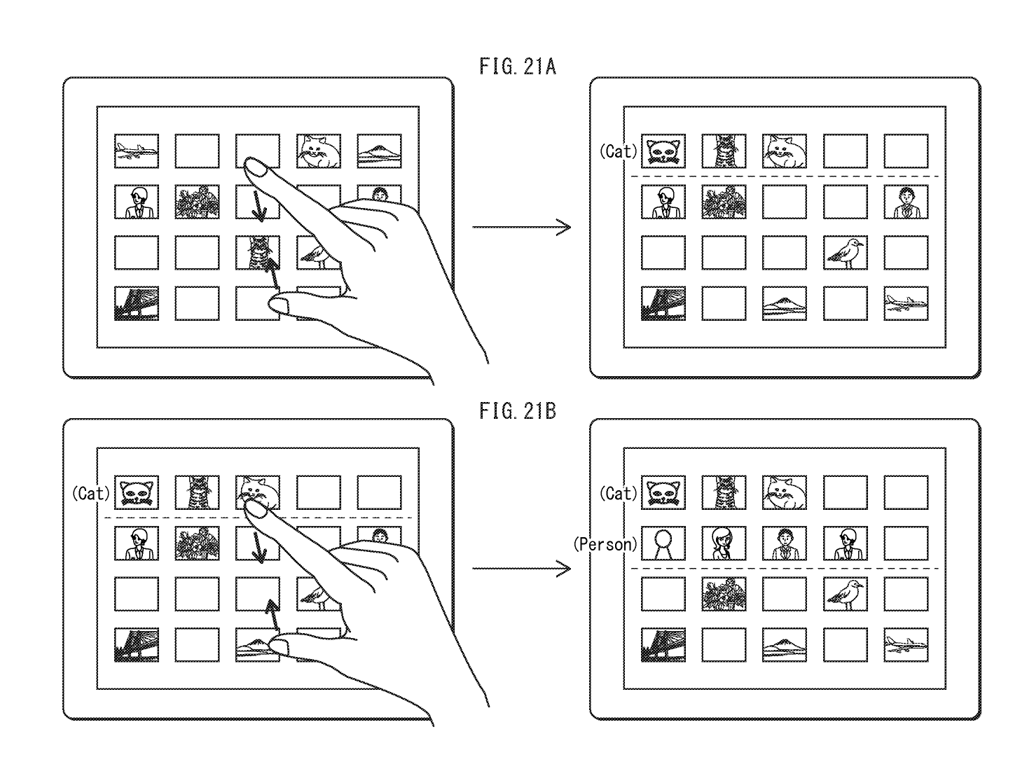

In Step S11, when as illustrated in FIG. 21A (left section) the possessed images are not arranged, in other words when the display processing target images are not categorized into one or more characteristic categories (Step S11: No), the content display processing device 1A performs processing in Steps S2-S5 in the same way as in Operation 1. However, when as illustrated in FIG. 21B (left section) the possessed images are already arranged under one or more display headings, in other words when the display processing target images are categorized into one or more characteristic categories (Step S11: Yes), images among the display processing target images which are not categorized into a characteristic category are determined to be categorization processing target images (Step S12). For example, when as illustrated in FIG. 21B (right section) one or more of the display processing target images are categorized into a characteristic category “People”, images among the display processing target images which are not categorized into the characteristic category “People” are determined to be categorization processing target images. The input instruction judgment unit 10 performs processing in Steps S11 and S12 with reference to the characteristic category categorization information stored in the characteristic category storage sub-unit 84.

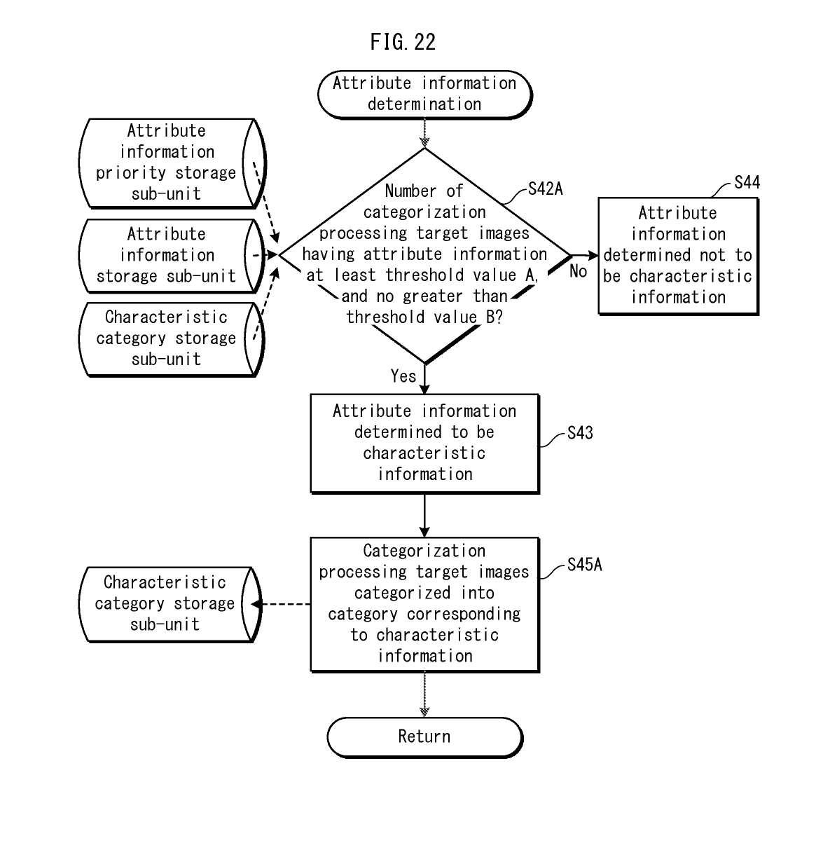

FIG. 22 is a flowchart illustrating processing order of characteristic information determination in Step S4A.

Step S4 of processing for characteristic information determination (FIG. 16) includes a step for calculating priorities of the pieces of attribute information (Step S41). However, when one or more of the display processing target images are already categorized into one or more characteristic categories (Step S11: Yes), priorities of the pieces of attribute information are already calculated, thus the step for calculating priorities of the pieces of attribute information is not included in Step S4A.

Processing in Steps S42A and S45A is fundamentally the same as in Steps S42 and S45 included in Step S4. However, in Step S42A pieces of attribute information acquired from the categorization processing target images are each determined whether to be a piece of characteristic information, in order of highest priority stored in the attribute information priority storage sub-unit 83. Also, in Step S45A the categorization processing target images are categorized into the characteristic categories calculated in Step S45A.

Thus, in the content display processing device 1A in modified example [2], when one or more of the display processing target images are already categorized into one or more characteristic categories, by determining categorization processing target images (Step S12) and pieces of characteristic information (Step S13), arrangement and display can be performed for images, among the display processing images, which are not already categorized into characteristic categories. Thus, arrangement of the display processing target images can be performed in a manner such that the number of characteristic categories increases each time a user operation is performed.

FIGS. 21A and 21B illustrate examples of display of the display processing target images in modified example [2]. As illustrated in FIGS. 21A and 21B, through the content display processing device 1A in modified example [2], arrangement of the display processing target images can be performed in a manner such that the number of display headings is increased each time a user operation is performed.

Furthermore, each time a user operation is performed a plurality of pieces of characteristic information may be determined, thus increasing the number of display headings by a plurality of display headings. In the above example, the number of display headings is increased each time a pinch-in operation is performed. In another example, the number of display headings may be decreased each time a pinch-out operation is performed.

Furthermore, the number of display headings may be increased in accordance with an amount of decrease in an interval between contact points during a pinch-in operation and decreased in accordance with an amount of increase in an interval between contact points during a pinch-out operation. In the above, instead of being in accordance with amount of increase or decrease of an interval between contact points during an operation, increase or decrease in the number of display headings may alternatively be in accordance with acceleration of the operation or a movement amount of contact points during the operation.

Increase or decrease in the number of display headings may be determined for example by measuring pressing time and movement distance of a finger on a touch panel display as physical parameters, and determining increase or decrease based on a measured value of the pressing time or movement distance, or based on acceleration (movement distance/pressing time). For example, for an acceleration of between 1 to 5 the number of display headings may be increased or decreased by a number equal to the acceleration (between 1 to 5), for an acceleration of between 0 to 1 the number of display headings may be left unchanged, and for an acceleration of 5 or greater the number of display headings may be increased or decreased by an upper limit of 5.

The present invention is not limited by the above display examples. For example, alternatively the display control unit 70 may add effects to each of the display heading rows on the display 3, such as an effect to show gathering of pieces of content, among the pieces of display processing target content, which are categorized under the display heading (characteristic information). Furthermore, the display control unit 70 may display the pieces of display processing target content under the display headings, and based on the priorities or the number of categorized pieces of content may for example display a line surrounding a piece of content or change background color of a piece of content.

### Second Embodiment

The content display processing device 1A relating to the first embodiment calculates the priority of each of the pieces of attribute information acquired from the pieces of content based on the reliability of the piece of attribute information and the pieces of usage information relating to use of the piece of attribute information by the user. The content display processing device 1A then determines the one or more pieces of characteristic information, each indicating an attribute which is characteristic of pieces of display processing target content, based on the calculated priorities of the pieces of attribute information. The content display processing device 1A subsequently arranges and displays the pieces of display processing target content in characteristic categories corresponding one-to-one to the pieces of characteristic information which are determined. In contrast to the above, a content display processing device relating to a second embodiment further performs setting of level relationship between the pieces of attribute information in accordance with the attribute types of the pieces of attribute information. The content display processing device relating to the second embodiment subsequently determines one or more pieces of characteristic information for pieces of display processing target content based on the priorities of the pieces of attribute information and further based on the level relationships which are set between the pieces of attribute information. The following explains configuration and operation of the content display processing device relating to the second embodiment with reference to the drawings. Aspects of configuration and operation of the content display processing device relating to the second embodiment which are the same as the content display processing device 1A relating to the first embodiment are labeled using the same reference signs and explanation thereof is omitted.

(Configuration)

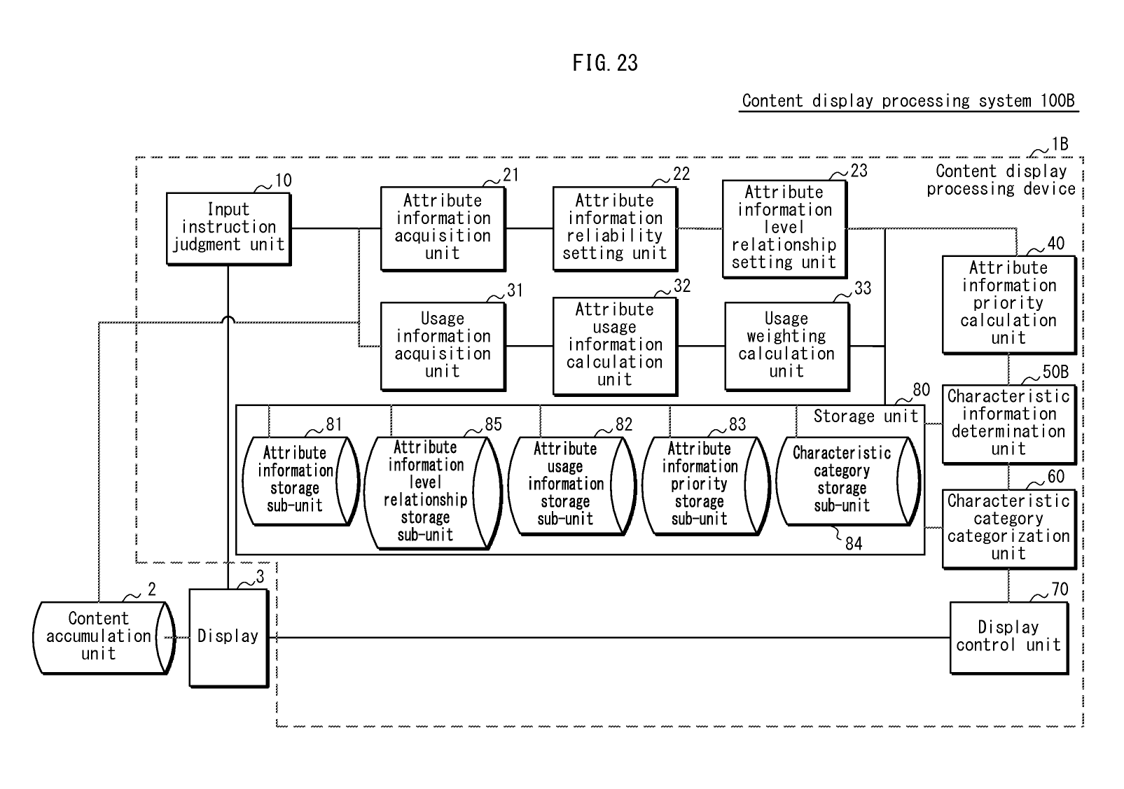

FIG. 23 is a block diagram of a content display system 100B relating to the present embodiment.

As illustrated in FIG. 23, a content display processing device 1B relating to the second embodiment includes an attribute information level relationship setting unit 23 and an attribute information level relationship storage sub-unit 85 in addition to configuration of the content display processing device 1A relating to the first embodiment (FIG. 1).

The attribute information level relationship setting unit 23 sets level relationships between the pieces of attribute information acquired by the attribute information acquisition unit 21, and subsequently stores in the attribute information level relationship storage sub-unit 85, information relating to the relationships set between the pieces of attribute information. The relationships between the pieces of attribute information are for example set in accordance with the attribute types of the pieces of attribute information or attributes indicated by the pieces of attribute information.

The content display processing device 1B includes a characteristic information determination unit 50B instead of the characteristic information determination unit 50A included in the content display processing device 1A.

The characteristic information determination unit 50B determines one or more pieces of characteristic information from among the pieces of attribute information acquired by the attribute information acquisition unit 21. The characteristic information determination unit 50B determines the pieces of characteristic information based on the priorities of the pieces of attribute information calculated by the attribute information priority calculation unit 40, the information stored in the attribute information storage sub-unit 81 indicating which of the pieces of content each of the pieces of attribute information is acquired from, the characteristic category categorization information of each of the pieces of content stored in the characteristic category storage sub-unit 84, and the level relationships between the pieces of attribute information set by the attribute information level relationship setting unit 23.

The following explains with reference to FIG. 23, a method used by the attribute information level relationship setting unit 23 for setting level relationships between the pieces of attribute information.

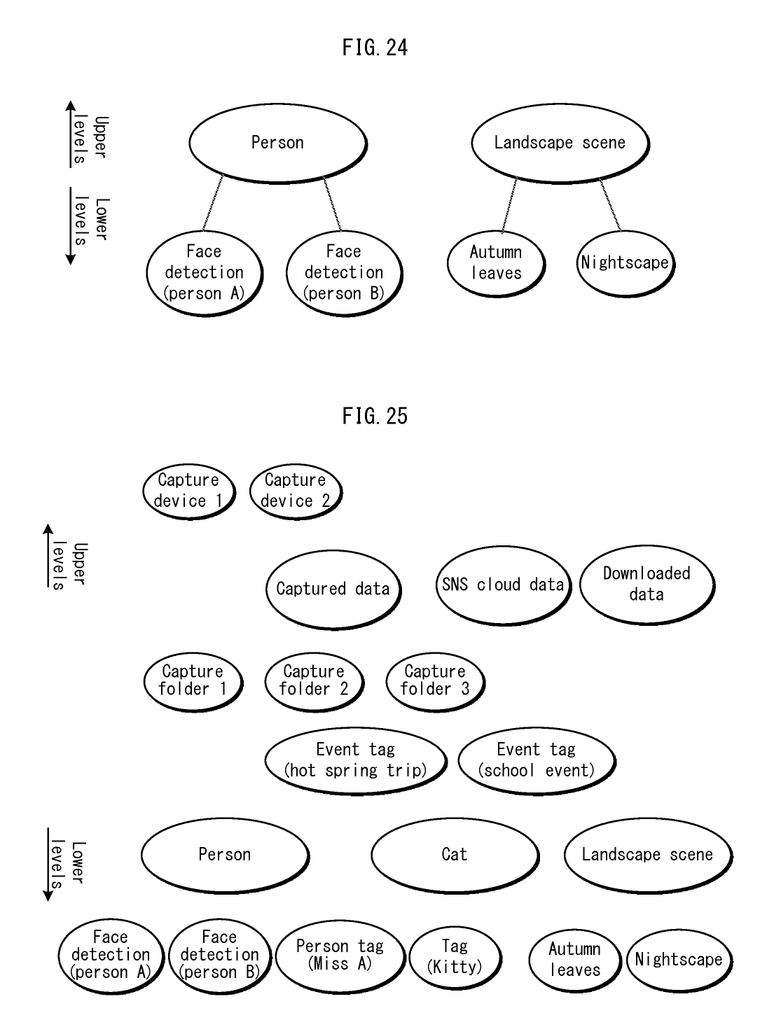

FIG. 24 is a schematic diagram illustrating an example of level relationships set between the pieces of attribute information. Level relationships are preset in the attribute information level relationship setting unit 23. For example, between attribute types of “Object detection (person)” and “Object detection (face)”, an upper/lower level relationship is preset (upper level: “Object detection (person”); lower level: “Object detection (face)”). Thus, the attribute information level relationship setting unit 23 sets an upper/lower level relationship such as illustrated in FIG. 24 (left) between a piece of attribute information “Person” of an attribute type “Object detection (person)”, and pieces of attribute information “Face A”, “Face B” and “Face C” each of an attribute type “Object detection (face)”.

Through setting of level relationships between the pieces of attribute information such as described above, the level relationships between the pieces of attribute information can be reflected in determination of the pieces of characteristic information. For example, when further arranging pieces of content which are arranged and displayed in a characteristic category corresponding to the piece of attribute information “Person”, the characteristic information determination unit 50B may prioritize the pieces of attribute information “Face A”, “Face B” and “Face C”, which each have a lower level relationship to the piece of attribute information “Person”, when determining the pieces of characteristic information. Also, when for example a user instruction is for expansion from a piece of content which is categorized and displayed in a characteristic category corresponding to the piece of attribute information “Face A” to pieces of content related to the piece of attribute information “Face A”, the characteristic information determination unit 50B may prioritize the piece of attribute information “Person”, which has an upper level relationship to the piece of attribute information “Face A”, when determining the pieces of characteristic information.

The attribute information level relationship setting unit 23 is not limited by the above, and alternatively may for example set an upper/lower level relationship between attribute types “Object detection (person)” and “Person tag” in advance, and subsequently set an upper/lower level relationship between the piece of attribute information “Person” and the pieces of attribute information “Miss D” and “Mr. E” each of an attribute type “Person tag”. Also, in another example the same method may be used to set a level relationship between a piece of attribute information “Landscape”, and pieces of attribute information “Autumn leaves” and “Nightscape”, each acquired through scene detection.

Alternatively, the attribute information level relationship setting unit 23 may set level relationships between the pieces of attribute information (a level of each of the pieces of attribute information) as illustrated in FIG. 25.

FIG. 25 is a schematic diagram illustrating one example of levels set for the pieces of attribute information. A level for each attribute type is preset in the attribute information level relationship setting unit 23. For example the attribute information level relationship setting unit 23 may set levels of pieces of attribute information in a manner such as shown in FIG. 25, wherein an uppermost layer includes pieces of attribute information “Capture device 1” and “Capture device 2” of an attribute type “Capture device”, a next level down includes pieces of attribute information “Captured data”, “SNS cloud data” and “Downloaded data” of an attribute type “Content acquisition source”, a next level down includes pieces of attribute information “Capture folder 1”, “Capture folder 2” and “Capture folder 3” of an attribute type “Content storage location”, and so on.

Through setting levels for the pieces of attribute information as described above, the levels of the pieces of attribute information can be reflected when determining the pieces of characteristic information. For example, when a user operation is for further arranging pieces of content arranged and displayed in a characteristic category corresponding to one piece of attribute information, the characteristic information determination unit 50B may determine one or more pieces of characteristic information from among pieces of attribute information of a lower level than the one piece of attribute information. Furthermore, when for example a user operation is for expansion from pieces of content which are arranged and displayed in a characteristic category corresponding to one piece of attribute information to pieces of content which have a piece of attribute information related to the one piece of attribute information, the characteristic information determination unit 50B may determine one or more pieces of characteristic information from among pieces of attribute information of a higher level than the one piece of attribute information.

Furthermore, the attribute information level relationship setting unit 23 may set level relationships between the pieces of attribute information (a level of each of the pieces of attribute information) as illustrated in both FIGS. 24 and 25, and both types of level relationship may be used in determination of the pieces of characteristic information.

The above explains a method of setting level relationships between the pieces of attribute information (a level of each of the pieces of attribute information) in accordance with the attribute types of the pieces of attribute information, however the method of setting level relationships is not limited to the above. Alternatively, an ontology technique may be used to construct a word level structure (network). The ontology technique may for example be used to link a piece of attribute information “Cat” of an attribute type “Tag” to a piece of attribute information “Cat” of an attribute type “Detected object (cat)”, and both of the above pieces of attribute information may be treated as the same piece of attribute information “Cat”. Also, the ontology technique may be used for example to set a level relationship between a piece of attribute information “Autumn leaves” of an attribute type “Tag” and a piece of attribute information “Landscape” of an attribute type “(Image analysis) scene”.

(Operation)

The following explains operation of the content display processing device 1B relating to the second embodiment. As a specific example, an example is given in which arrangement and display processing is performed with regards to a plurality of images.

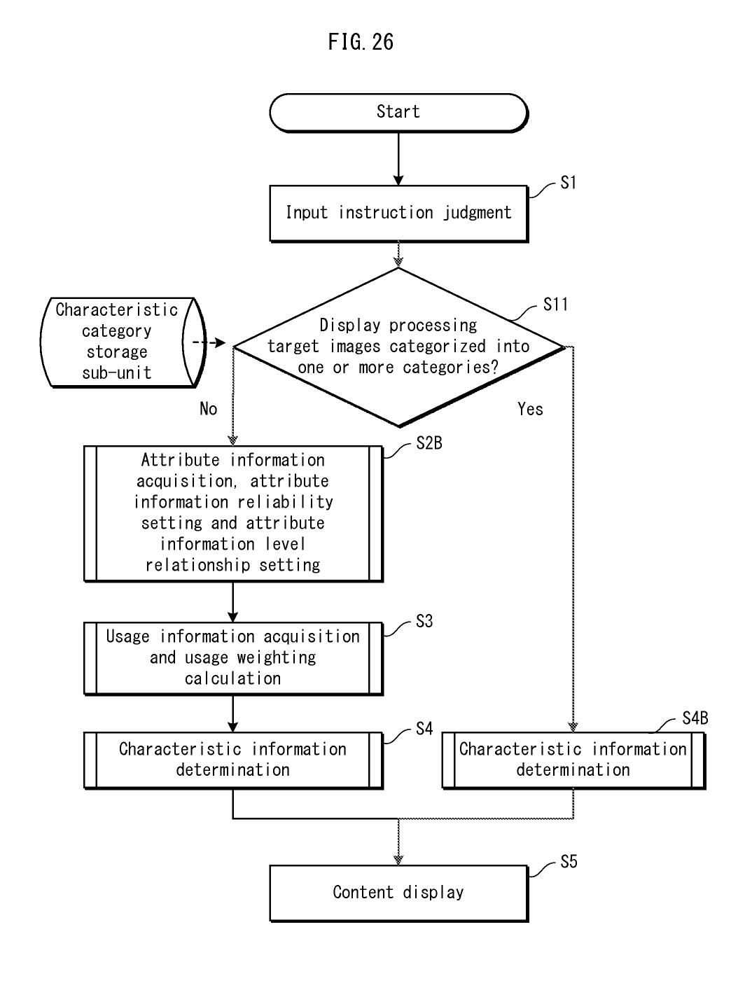

FIG. 26 is a flowchart illustrating processing order of operations performed by the content display processing device 1B.

First, in the same way as in Operation 1 relating to the first embodiment, a user operation such as a pinch-in operation is performed with respect to all possessed images displayed in list format on the display 3. Suppose that at the time of the above operation the possessed images are not already categorized into one or more characteristic categories.

In Step S1 the input instruction judgment unit 10 judges that an objective of content display processing is image arrangement and that all possessed images are display processing target images, in the same way as in Operation 1 relating to the first embodiment.

Next, in Step S11 the input instruction judgment unit 10 judges whether one or more of the display processing target images are already categorized into one or more characteristic categories, while referring to the characteristic category storage sub-unit 84. The display processing target images, which in other words are all possessed images, are not categorized into characteristic categories (Step S11: No), therefore processing proceeds to Step S2B.

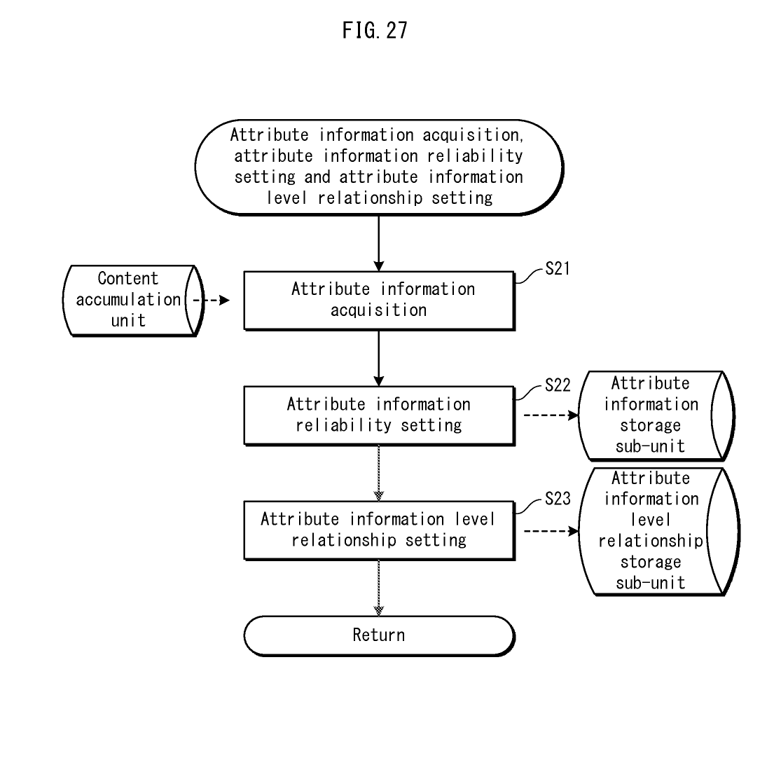

FIG. 27 is a flowchart illustrating processing order of Step S2B.

In Step S2B, processing in Step S21 (attribute information acquisition) and Step S22 (attribute information reliability setting) is performed in the same way as in Operation 1 relating to the first embodiment.

Next, in Step S23 the attribute information level relationship setting unit 23 sets level relationships between the pieces of attribute information and stores the level relationships in the attribute information level relationship storage sub-unit 85. The attribute information level relationship setting unit 23 for example sets a level relationship between a piece of attribute information “Person” and each of pieces of attribute information “Face A”, “Face B” and “Face C” as illustrated in FIG. 24 (left).

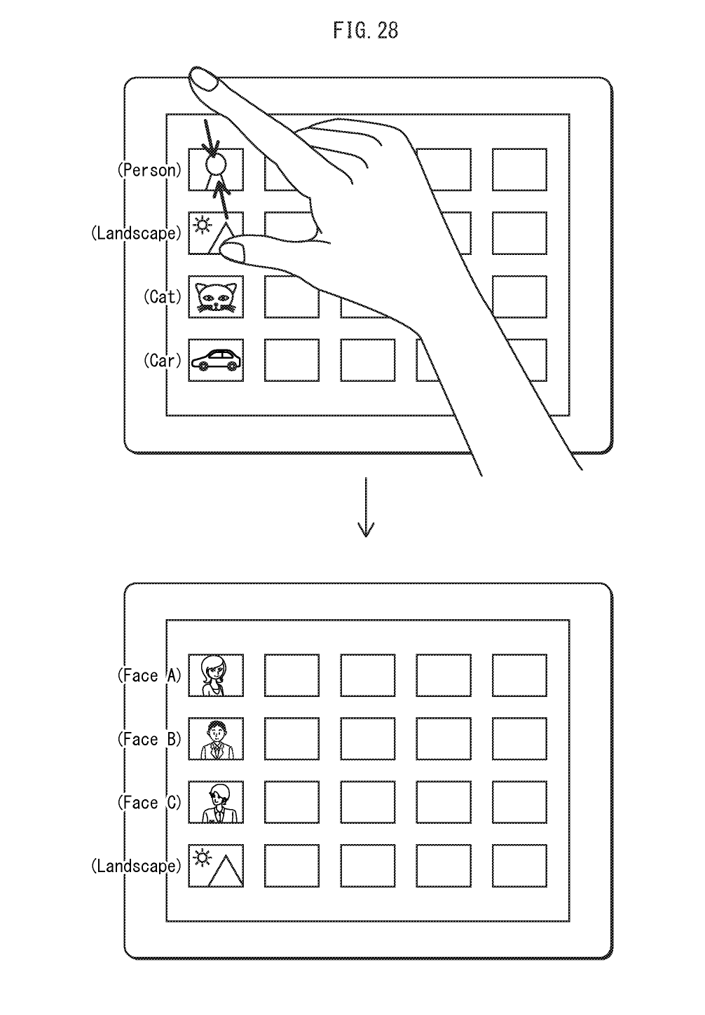

Next, processing in Steps S3-S5 is performed in the same way as in Operation 1 relating to the first embodiment, thus arranging and displaying the display processing target images as illustrated in FIG. 28 (upper section). In FIG. 28 (upper section) the display processing target images are arranged and displayed in characteristic categories “Person”, “Landscape”, “Cat” and “Car”.

Next, suppose that an input operation is performed by the user while images are arranged and displayed as illustrated in FIG. 28 (upper section), for example a pinch-in operation on a “Person” thumbnail indicating arrangement in the characteristic category “Person”.

In Step S1, the input instruction judgment unit 10 judges that due to the input operation being a pinch-in operation, the objective of content display processing is image arrangement. The input instruction judgment unit 10 also judges that due to the input operation being performed on the “Person” thumbnail, images categorized in the characteristic category “Person” are display processing target images.

Next, in Step 11 the input instruction judgment unit 10 refers to the characteristic category storage sub-unit 84, and processing proceeds to Step S4B due to the display processing target images being categorized in the characteristic category “Person” (Step S11: Yes).

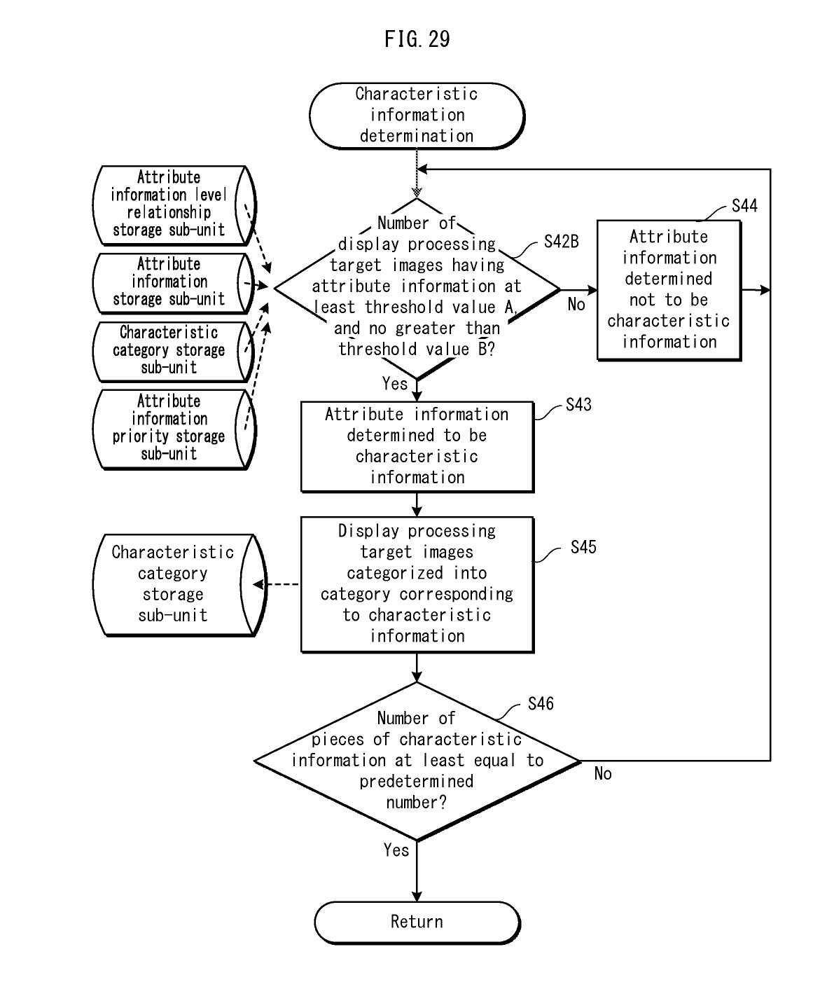

FIG. 29 is a flowchart illustrating operations in Step S4B.

The characteristic information determination unit 50B first refers to the level relationships between the pieces of attribute information stored in the attribute information level relationship storage sub-unit 85. When there are one or more pieces of attribute information of a lower level relationship to a piece of attribute information which the display processing target images are categorized as, the characteristic information determination unit 50B determines one or more pieces of characteristic information from among the pieces of attribute information of lower level relationship in order of highest priority thereof (Step S42B).

For example, when the display processing target images are categorized as the piece of attribute information “Person”, if any of the display processing target images have pieces of attribute information of a lower level relationship such as “Face A”, “Face B” and “Face C”, the characteristic information determination unit 50B determines whether or not each of the pieces of attribute information “Face A”, “Face B” and “Face C” is a piece of characteristic information in order of highest priority (Step S42 B).

On the other hand, in Step S42B when none of the display processing target images have a piece of attribute information of a lower level relationship to the piece of attribute information which the display processing target images are categorized as, one or more pieces of characteristic information are determined based on priorities of the pieces of attribute information stored in the attribute information priority storage sub-unit 83, in the same way as in Operation 1 relating to the first embodiment. Processing in Steps S43-S46 is the same as in Operation 1 relating to the first embodiment.

FIG. 28 (lower section) illustrates an example in which the images arranged and displayed in the characteristic category corresponding to the piece of attribute information “Person” are further arranged and displayed in characteristic categories “Face A”, “Face B” and “Face C”. As illustrated in FIG. 28 (lower section), through the content display processing device 1B, display processing target images categorized into one or more characteristic categories which each correspond to one piece of attribute information, can be arranged and displayed for pieces of attribute information each having a lower level relationship to the one piece of attribute information. Furthermore, instead of arrangement and display of the display processing target images, expansion and display can be performed from the display processing target images classified into one or more characteristic categories each corresponding to one piece of attribute information, to pieces of attribute information of an upper level relationship to the one piece of attribute information.

(Summary)

In addition to functions of the content display processing device 1A relating to the first embodiment, the content display processing device 1B relating to the second embodiment sets level relationships between the pieces of attribute information and determines one or more pieces of characteristic information for the pieces of display processing target content further based on the level relationships between the pieces of attribute information. Consequently, the content display processing device 1B relating to the second embodiment is able to arrange and display pieces of content in a manner which reflects relationships between the pieces of attribute information.

### Modified Examples

### Part 2

### Modified Example [1]

The content display processing devices relating to the first and second embodiments are each explained as including an input instruction judgment unit, and performing display processing on a plurality of contents after receiving an instruction from a user relating to content display, but the present invention is not limited by the above. For example, the input instruction judgment unit may be removed from configuration of the content display processing devices relating to the first and second embodiments, and alternatively predetermined content display processing may be automatically performed in response to a certain trigger event. Further alternatively, each of the processing steps performed by the content display processing device in the first embodiment may be implemented as a computer program executed by a computer. Through the computer program, arrangement and display processing may be performed automatically, for example for all pieces of content possessed by a user. The computer program may be distributed as software or an application, wherein download or start-up of the software or application may be the trigger event for performing content display processing.

### Modified Example [2]

In the content display processing devices relating to the first and second embodiments, a resistive film type touch panel is used as an example of a display, but the above is not a limitation and alternatively a capacitive type touch panel, ultra-sonic type touch panel or the like may be used. Through use of a touch panel for a display, as in the content display processing devices relating to the first and second embodiments, an input operation by a user can be received such as a tap operation directly indicating a target on the display such as an icon, a drag operation moving a target, a flick operation causing screen scrolling, a pinch-out operation causing enlargement or expansion of a target, or a pinch-in operation causing reduction or convergence of a target.

The content display processing devices relating to the first and second embodiments are not limited to receiving input operations through a touch panel as described above, and alternatively may receive indirect input operations through a mouse, keyboard or the like. In the content display processing devices relating to the first and second embodiments, the content display processing device is able to receive various input operations due to linking in advance of the input instructions to various types of content display processing performed by the content display processing device.

### Modified Example [3]

In the first and second embodiments the content accumulation unit and the storage unit are explained as storage in which content data possessed by the user is accumulated, but the content accumulation unit and the storage unit are not limited by the above and may alternatively be configured by a cloud storage service. By configuring the content accumulation unit and the storage unit using the cloud storage service, the content display processing devices relating to the first and second embodiments can perform total management of pieces of content and usage information relating to usage of each piece of content by the user. The content display processing devices relating to the above embodiments may alternatively perform content display processing with regards to pieces of content shared over a network such as an SNS.

### Modified Example [4]

In the first and second embodiments the “usage information” is explained as being usage metadata such as a content display count, a print count, album processing information and SNS sharing information, and various types of usage metadata such as illustrated in FIG. 4 may be used as pieces of usage information. The usage information in the first and second embodiments is not limited to the usage metadata illustrated in FIG. 4, and information relating to a comment posted by a user on an SNS, an identity of a user posting a comment, and a posting time of a comment may also each be used as a piece of usage information. Also, information relating to an operation by a user with regards to a piece of content, a time or frequency of an operation, information relating to combinations of performed operations may also for example each be used as a piece of usage information. A piece of history information regarding change in the number of pieces of content accumulated in the content accumulation unit may also be used as a piece of usage information. Also, information relating to a web page searched by user which can be linked to a piece of content accumulated in the content accumulation unit may also be used as a piece of usage information. Furthermore, information relating to an application used for editing or processing a piece of content may also be used as a piece of usage information.

### Modified Example [5]

As explained in the first and second embodiments, the “attribute information” may be metadata attached to each piece of content including device metadata, analysis metadata and usage metadata, as illustrated for example in FIGS. 2-4. Alternatively, information other than the metadata illustrated in FIGS. 2-4 may be used as a piece of attribute information in the first and second embodiment. For example, information relating to a comment posted by a user on an SNS, an identity of a user posting a comment, and a posting time of a comment may also each be used as a piece of attribute information. Also, information relating to an operation on a piece of content by a user, time or frequency of an operation, or information relating to a combination of operations may be used as a piece of attribute information. A piece of history information relating to change in the number of pieces of content stored in the content accumulation unit may also be used as a piece of attribute information. Furthermore, information relating to a web page searched by a user which is linkable to a piece of content stored in the content accumulation unit may also be used as a piece of attribute information. Information relating to an application used in editing, processing or the like of a piece of content may also be used as a piece of attribute information. Various other types of information may be used as pieces of attribute information, so long as the information can be recognized by the user as being an attribute which is characteristic of pieces display processing target content.

Further alternatively, the various pieces of attribute information described above may for example be associated using an operation history or an ontology technique. In the above situation, reliability of each piece of attribute information may be set based on a degree of certainty of the method used for association of the pieces of attribute information.

### Modified Example [6]

In the first and second embodiments, the operation weightings used to calculate the usage weightings are explained as each being set in advance in accordance with a degree of importance associated with the operation. In addition to the above, each of the operation weightings may also be changed in accordance with a time of the operation. For example, using a time at which the operation weighting is calculated as a reference time, the operation weighting may be calculated as a higher value for a display operation performed within a month of the reference time than compared to a display operation performed a year or more prior to the reference time. Thus, by using the time at which the operation weighting is calculated as the reference time, an operation performed at a time close to the reference time may be considered to be of greater importance to the user, and thus the operation weighting of the operation may be set higher. On the other hand, an operation performed at a time distant to the reference time may be considered to be of lesser importance to the user, and thus the operation weighting of the operation may be set lower.

### Modified Example [7]

The content display processing devices relating to the first and second embodiments are each described as determining one or more pieces of characteristic information, each indicating an attribute which is characteristic of pieces of display processing target content, based on pieces of attribute information and pieces of usage information acquired not only from the pieces of display processing target content, but from all pieces of content accumulated in the content accumulation unit. However, the above is not a limitation on the present invention. Alternatively, the content display processing devices relating to the first and second embodiments may determine the pieces of characteristic information based on pieces of attribute information and pieces of usage information acquired only from the pieces of display processing target content.

### Modified Example [8]

In the content display processing devices relating to the first and second embodiments, processing for characteristic information determination and processing for display processing target image categorization are explained as being performed in a manner such that each of the display processing target images is not categorized into a plurality of characteristic categories. However, the above is not a limitation on the present invention. Alternatively, the content display processing devices relating to the first and second embodiments may perform processing for characteristic information determination and processing for display processing target image categorization in a manner such that each of the display processing target images may be categorized into a plurality of characteristic categories. When an image among the display processing target images is categorized into a plurality of characteristic categories, the display may be controlled to display the image in a manner such that the user can understand that the image has a plurality of pieces of characteristic information. For example, if the image is categorized into characteristic categories “Person” and “Cat”, the image may be displayed under two different display headings, each corresponding to one of the characteristic categories.

### Modified Example [9]

The content display processing devices relating to the first and second embodiments are each explained as calculating a priority of each piece of attribute information using a reliability and a usage weighting of the piece of attribute information, and subsequently determining one or more pieces of characteristic information, each indicating an attribute which is characteristic of pieces of display processing target content, based on the priorities of the pieces of attribute information. However, the above is not a limitation on the present invention. One or more pieces of characteristic information may alternatively be determined using any of the methods described below.

(i) A priority of each piece of attribute information is calculated in the same way as in the first and second embodiments. Subsequently, the characteristic information determination unit may determine whether or not each of the pieces of attribute information is a piece of characteristic information, based on comparison of the priority of the piece of attribute information with a reference value which is dependent on an attribute type of the piece of attribute information. For example, in a situation where a piece of attribute information A has a reliability T_{A}, a usage weighting W_{A}, and is of an attribute type B having a reference value V_{B}, the piece of attribute information A may be determined to be a piece of characteristic information when the piece of attribute information A has a priority (=T_{A}×[1+W_{A}]) of greater than V_{B}.

Through setting of a reference values which is dependent on attribute type of each of the pieces of attribute information, a piece of attribute information can be prioritized when determining the pieces of characteristic information, in accordance with an attribute type of the piece of attribute information. For example, by setting a low reference value for a piece of attribute information “Person”, the piece of attribute information “Person” can be prioritized when determining the pieces of characteristic information.

(ii) A piece of attribute information may be determined to be a piece of characteristic information when the piece of attribute information is acquired from at least A and no more than B pieces of content among the pieces of display processing target content. Through determination of the pieces of characteristic information by setting threshold values such as described above, common headings can be extracted which are appropriate for display of the pieces of display processing target content. The threshold values may be set in advance in accordance with the number of pieces of display processing target content and the number of pieces of content which can be displayed on a screen of the display.

(iii) Information may be acquired from the Internet relating to popular world trends and the pieces of characteristic information may be determined from among pieces of attribute information based on a degree of popularity of each of the pieces of attribute information. For example, when a large number searches on the Internet are performed using words related to “Olympics”, a piece of attribute information related to “Olympics” may be prioritized when determining the pieces of characteristic information.

(iv) A piece of content tagged by a user may be considered to be a piece of content in which the user has a high degree of interest. Consequently, a piece of attribute information, other than the tag, which is acquired from the same piece of content may also be inferred to be a piece of attribute information in which the user has a high degree of interest. Therefore, by setting a high priority for a piece of attribute information acquired from a piece of content which is tagged, the piece of attribute information may be prioritized when determining the pieces of characteristic information. In a specific example, when a piece of attribute information “Face A” is acquired from an image having a tag “Sports day” attached thereto, a high priority may be set for the piece of attribute information “Face A”.

Alternatively, a high priority may be set for a piece of attribute information which is associated using an ontology technique with matter indicated by a tag, thus prioritizing the piece of attribute information when determining the pieces of characteristic information. In a specific example, a high priority may be set for a piece of attribute information “Landscape (scene detection)” which is associated with a tag “Autumn leaves”. Furthermore, when a piece of attribute information “Face A” is acquired from an image having a tag “Miss A” attached thereto, “Miss A” may be judged to be equivalent to “Face A”, thus treating “Miss A” and “Face A” as a single piece of attribute information “Miss A (face A)”, and a high priority may be set for the piece of attribute information “Miss A (face A)”.

(v) When both face A and face B appear in a large number of display processing target images, a piece of attribute information “Face A” and a piece of attribute information “Face B” may be treated as a single piece of attribute information “Face A and face B”, and a high priority may be set for the piece of attribute information “Face A and face B”.

(vi) Alternatively, any of the methods for characteristic information determination described above may be combined, thus calculating a priority for each of the pieces of attribute information which is an overall priority calculated using the combined methods, and subsequently determining the pieces of characteristic information using the overall priorities. Furthermore, the method for characteristic information determination may be changed in accordance with the objective of content display processing. For example, the method for characteristic information determination may be changed in accordance with whether the objective for content display processing is arrangement or expansion.

### Modified Examples

### Part 3

A content display processing device relating to one aspect of the present invention is explained above based on the embodiments, but the present invention is not limited by the embodiments. Various modifications of the embodiments that might be conceived by persons having common knowledge in the technical field of the invention are also included in the scope of the present invention, so long as such modifications do not deviate from the general technical concept of the present invention.

For example, in the content display processing devices relating to the first and second embodiments, some or all of the configuration elements thereof may be configured by a single system LSI (Large Scale Integration).

A system LSI is a multi-functional LSI which is manufactured by integrating a plurality of configuration elements onto a single chip. Specifically, the LSI may be a computer system configured by a microprocessor, a ROM (Read Only Memory), a RAM (Random Access Memory), and the like. A computer program is stored on the ROM. The system LSI implements the various functions by operation of the microprocessor in accordance with the computer program.

The above refers to system LSI, but depending on the degree of integration the above may alternatively be referred to as IC, LSI, super LSI or ultra LSI. The method of integration is not limited to LSI, and alternatively may be implemented by a dedicated circuit or a general processor. Alternatively, after construction of an LSI, a programmable FPGA (Field Programmable Gate Array) or a reconfigurable processor capable of reconfiguring settings and connections between circuit cells in the LSI may be used.

Furthermore, if a new circuit integration technique that could replace LSI were to arise from advances in semi-conductor technologies or semi-conductor derived technologies, the new technique could of course be used for the integration of functional blocks. One possibility lies in adaptation of biotechnology.

Also, the present invention is not limited to being implemented as a content display processing device which includes the configuration elements which are features of the present invention. Alternatively, the present invention may be implemented as a content display processing method in which the configuration elements which are features of the present invention are implemented as steps in the content display processing method. Further alternatively, the steps of the above method which are features of the present invention may be implemented by execution of a computer program by a computer. A computer program such as described above may of course be distributed through a communication network or using a non-transient computer-readable recording medium such as a CD-ROM.

(Supplementary Explanation)

The following explains configuration, modified examples and effects thereof for a content display processing device, and a content display processing method, program and integrated circuit as one embodiment of the present invention.

(1) A content display processing device relating to one embodiment of the present invention comprises: a display unit; a content acquisition unit configured to acquire a plurality of pieces of content; an attribute information acquisition unit configured to acquire one or more pieces of attribute information, each of the pieces of attribute information being acquired from one or more of the plurality of pieces of content and indicating an attribute thereof; a characteristic information determination unit configured to determine a piece of characteristic information based on the pieces of attribute information, the piece of characteristic information pertaining to one or more pieces of target content among the plurality of pieces of content and indicating an attribute which is characteristic thereof; and a display control unit configured to control the display unit to display the pieces of target content, based on the piece of characteristic information.

Through the above configuration, pieces of display processing target content (pieces of target content) can be arranged (expanded) and displayed on various arrangement axes which change in accordance with the pieces of display processing target content.

(2) The content display processing device of section (1) may further comprise an instruction acquisition unit configured to acquire a piece of instruction information from a user relating to content display, wherein the characteristic information determination unit may determine the piece of characteristic information further based on the piece of instruction information.

Through the above configuration, the pieces of display processing target content can be arranged and displayed in a manner which reflects the instruction from the user.

(3) The content display processing device of section (2) may further comprise a reliability setting unit configured to set a reliability of each of the pieces of attribute information, based on a type of the piece of attribute information, wherein the characteristic information determination unit may determine the piece of characteristic information further based on the reliabilities of the pieces of attribute information.

Through the above configuration, the pieces of display processing target content can be arranged and displayed in a manner which reflects the reliability of each of the pieces of attribute information, which is dependent on the attribute type of the piece of attribute information. For example, by setting reliabilities which indicate certainty of pieces of attribute information of each attribute type, a piece of attribute information with a high reliability can be prioritized when determining the piece of characteristic information. Furthermore, by setting a high reliability for a piece of attribute information such as “Person”, “Face” or “Person A” which relates to an object “Person” appearing in an image, the piece of attribute information relating to the object “Person” can be prioritized when determining the piece of characteristic information.

(4) The content display processing device of section (3) may further comprise: a first usage information acquisition unit configured to acquire for each of the plurality of pieces of content, a piece of first usage information indicating usage by the user of the piece of content; a second usage information calculation unit configured to calculate for each of the pieces of attribute information, a piece of second usage information indicating usage by the user of the one or more pieces of content from which the piece of attribute information is acquired; and a priority calculation unit configured to calculate a priority of each of the pieces of attribute information, based on the reliability and the second usage information thereof, wherein the second usage information calculation unit calculates the piece of second usage information based on pieces of first usage information of the one or more pieces of content from which the piece of attribute information is acquired, and the characteristic information determination unit determines the piece of characteristic information further based on the priorities of the pieces of attribute information.

Through the above configuration, the pieces of display processing target content can be arranged and displayed in a manner which reflects pieces of usage information relating to usage of the plurality of pieces of content by the user. As a specific example, a piece of attribute information of a piece of content for which a display operation is often performed by the user can be inferred to be a piece of attribute information that the user is interested in, and therefore the piece of attribute information can be prioritized when determining the piece of characteristic information.

(5) The content display processing device of section (3) may further comprise: a statistical information calculation unit configured to calculate a piece of statistical information of each of the pieces of attribute information, based on a number of pieces of content from which the piece of attribute information is acquired; and a priority calculation unit configured to calculate a priority of each of the pieces of attribute information, based on the reliability and the piece of statistical information thereof, wherein the characteristic information determination unit determines the piece of characteristic information further based on the priorities of the pieces of attribute information.

Through the above configuration, the pieces of display processing target content can be arranged and displayed in a manner which reflects trends in the pieces of attribute information with regards to the plurality of pieces of content. For example, when a large number of images having a piece of attribute information “Cat” are included among the plurality of pieces of content, the piece of attribute information “Cat” can be prioritized when determining the piece of characteristic information.

(6) In the content display processing device of section (3), one or more of the pieces of attribute information may be manually attached by a user, the content display processing device may further comprise: a relationship information calculation unit configured to calculate relationship information for each of the pieces of attribute information which is not manually attached, the relationship information indicating a relationship to each of the pieces of attribute information which is manually attached; and an attribute information priority calculation unit configured to calculate a priority of each of the pieces of attribute information which is manually attached based on the reliability thereof, and calculate a priority of each of the pieces of attribute information which is not manually attached based on the reliability and the relationship information thereof, and the characteristic information determination unit may determine the piece of characteristic information further based on the priorities of the pieces of attribute information which are manually attached and the priorities of the pieces of attribute information which are not manually attached.

Through the above configuration, the pieces of display processing target content can be arranged and displayed in a manner which reflects pieces of attribute information which are manually attached, such as tags attached by a user. The pieces of display processing target content can also be arranged and displayed in a manner which reflects relationships between the pieces of attribute information which are manually attached and other pieces of attribute information which are not manually attached. For example, a tag is a piece of attribute information which is directly attached by a user, and therefore a piece of content which is tagged may be considered to be a piece of content which is of interest to the user. Also, a piece of attribute information, other than the tag, which is acquired from the piece of content which is tagged may also be considered to be a piece of attribute information which is of interest to the user. Therefore, the piece of attribute information can be prioritized when determining the piece of characteristic information. Furthermore, when a piece of content is tagged with a piece of attribute information “Landscape”, pieces of attribute information such as “Autumn leaves” and “Nightscape” which are associated with the piece of attribute information “Landscape” may be prioritized when determining the piece of characteristic information. An ontology technique in which general concept of words is analyzed to construct a network is an example of a method which may be used to set relationship information between a tag and a piece of attribute information related to the tag.

(7) The content display processing device of section (4) may further comprise a target content determination unit configured to determine the pieces of target content from among the plurality of pieces of content based on the piece of instruction information which is acquired, wherein the characteristic information determination unit may determine the piece of characteristic information based on pieces of information relating to the pieces of target content.

Through the above configuration, the pieces of display processing target content can be determined in accordance with the piece of instruction information from the user.

(8) The content display processing device of section (7) may further comprise a display objective judgment unit configured to judge whether an objective of content display is arrangement or expansion, based on the piece of instruction information which is acquired, wherein the target content determination unit may determine the pieces of target content based on the objective of content display.

Through the above configuration, an objective of content display can be judged whether to be arrangement or expansion, and the pieces of display processing target content can be determined based on the objective of content display.

(9) The content display processing device of section (3) may further comprise a level information setting unit configured to set a piece of level information of each of the pieces of attribute information, based on the type of the piece of attribute information, wherein the characteristic information determination unit may determine the piece of characteristic information further based on the pieces of level information of the pieces of attribute information.

Through the above configuration, the pieces of display processing target content can be arranged and displayed in a manner which reflects pieces of level information which are dependent on attribute types of the pieces of attribute information. For example, a level relationship may be set between a piece of attribute information “Person” and each of pieces of attribute information “Face A” and “Face B”, and when arranging images which are categorized into a characteristic category corresponding to the piece of attribute information “Person”, the images can be arranged in characteristic categories corresponding to the pieces of attribute information “Face A” and “Face B”. Alternatively, when arranging a plurality of pieces of content an arrangement grading may be determined based on the level. The arrangement grading may be considered to be broad when images are arranged for pieces of attribute information set at an upper level, for example pieces of attribute information related to storage location such as “Application 1”, “Application 2” and “Image capture folder”. On the other hand, arrangement grading may be considered to be fine when images are arranged for pieces of attribute information set at a lower layer, for example pieces of attribute information related to objects such as “Person”, “Cat” and “Car”. Through setting of level information such as described above, it is possible to change grading of arrangement and display of pieces of content.

(10) The content display processing device of either section (4) or section (9) may further comprise: a display objective judgment unit configured to judge whether an objective of content display is arrangement or expansion, based on the piece of instruction information which is acquired; and a target content determination unit configured to determine the pieces of target content from among the plurality of pieces of content, based on the piece of instruction information which is acquired, wherein the characteristic information determination unit may determine the piece of characteristic information based on the objective of content display and pieces of information relating to the pieces of target content.

Through the above configuration, the pieces of display processing target content are determined and the objective of content display is judged based on the piece of instruction information from the user. Therefore, the pieces of display processing target content can be arranged and displayed in a manner which reflects the objective of content display.

(11) The content display processing device of section (3) may further comprise: an accumulation unit configured to accumulate display history information relating to display of each of the pieces of content and usage history information relating to use of each of the pieces of content by the user, the display history information including the piece of instruction information which is acquired; and a priority calculation unit configured to calculate a priority of each of the pieces of attribute information, based on pieces of the display history information and the usage history information which relate to the one or more pieces of content from which the piece of attribute information is acquired, wherein the characteristic information determination unit may determine the piece of characteristic information further based on the priorities of the pieces of attribute information.

Through the above configuration, the pieces of display processing target content can be arranged and displayed in a manner which reflects the display history information relating to display of each of the pieces of content and the usage history information relating to usage of each of the pieces of content by the user.

(12) In the content display processing device of section (11), the priority calculation unit may calculate the priority of each of the pieces of attribute information further based on time series variation information for the pieces of the display history information and usage history information relating to the pieces of content from which the piece of attribute information is acquired.

Through the above configuration, the pieces of display processing target content can be arranged and displayed in a manner which reflects time series change of the display history information relating to display of the pieces of content and the usage history information relating to usage of the pieces of content by the user. For example, using a time at which content display processing is performed as a reference time, a piece of the display history information relating to content display performed within one month of the reference time may be prioritized when determining the piece of characteristic information, compared to a piece of the display history information relating to content display performed a year or more prior to the reference time.

(13) In the content display processing device of section (12), the usage history information may include pieces of posting information, searching information and linking information relating to usage of each of the pieces of content by the user via a network.

Through the above configuration, the pieces of display processing target content can be arranged and displayed in a manner which reflects usage of each of the pieces of content via a network by using pieces of posting information to a blog, SNS or the like for each of the pieces of content, pieces of search information for each of the pieces of content and pieces of linking information for each of the pieces of content.

(14) In the content display processing device of section (2), the display control unit may control the display unit to display the pieces of target content in a manner linked to a user operation performed with regards to content display.

Through the above configuration, the pieces of display processing target content can be displayed in a display format which the user can understand more intuitively.

(15) In the content display processing device of section (2), the characteristic information determination unit, when determining the piece of characteristic information, may prioritize pieces of time information, location information, person information, scene information and object information included among the pieces of attribute information.

Through the above configuration, the pieces of display processing target content can be arranged and displayed in terms of a certain time, location, person, scene or object.

(16) In the content display processing device of section (2), included among the pieces of attribute information may be pieces of metadata information attached automatically to the pieces of content, pieces of analysis information acquired through analysis of the pieces of content and pieces of tag information attached to the pieces of content by a user.

(17) A content display processing method relating to one embodiment of the present invention comprises: a content acquisition step of acquiring a plurality of pieces of content; an attribute information acquisition step of acquiring one or more pieces of attribute information, each of the pieces of attribute information being acquired from one or more of the plurality of pieces of content and indicating an attribute thereof; a characteristic information determination step of determining a piece of characteristic information based on the pieces of attribute information, the piece of characteristic information pertaining to one or more pieces of target content among the plurality of pieces of content and indicating an attribute which is characteristic thereof; and a display control step of controlling display of the pieces of target content, based on the piece of characteristic information.

Through the above configuration, the pieces of display processing target content (pieces of target content) can be arranged and displayed using various arrangement axes which change in accordance with the pieces of display processing target content.

(18) A program relating to one embodiment of the present invention causes a computer to execute content display processing, wherein the content display processing comprises: a content acquisition step of acquiring a plurality of pieces of content; an attribute information acquisition step of acquiring one or more pieces of attribute information, each of the pieces of attribute information being acquired from one or more of the plurality of pieces of content and indicating an attribute thereof; a characteristic information determination step of determining a piece of characteristic information based on the pieces of attribute information, the piece of characteristic information pertaining to one or more pieces of target content among the plurality of pieces of content and indicating an attribute which is characteristic thereof; and a display control step of controlling display of the pieces of target content, based on the piece of characteristic information.

Through the above configuration, the pieces of display processing target content (pieces of target content) can be arranged and displayed using various arrangement axes which change in accordance with the pieces of display processing target content.

(19) An integrated circuit relating to one embodiment of the present invention comprises: a content acquisition unit configured to acquire a plurality of pieces of content; an attribute information acquisition unit configured to acquire one or more pieces of attribute information, each of the pieces of attribute information being acquired from one or more of the plurality of pieces of content and indicating an attribute thereof; a characteristic information determination unit configured to determine a piece of characteristic information based on the pieces of attribute information, the piece of characteristic information pertaining to one or more pieces of target content among the plurality of pieces of content and indicating an attribute which is characteristic thereof; and a display control unit configured to control display of the pieces of target content, based on the piece of characteristic information.

Through the above configuration, the pieces of display processing target content (pieces of target content) can be arranged and displayed using various arrangement axes which change in accordance with the pieces of display processing target content.

### INDUSTRIAL APPLICABILITY

Through the content display processing device relating to the present invention, pieces of display processing target content can be arranged and displayed on arrangement axes which change in accordance with the pieces of display processing target content.

### REFERENCE SIGNS LIST

1A, 1B content display processing device
2 content accumulation unit
3 display
10 input instruction judgment unit
21 attribute information acquisition unit
22 attribute information reliability setting unit
23 attribute level relationship setting unit
31 usage information acquisition unit
32 attribute usage information calculation unit
33 usage weighting calculation unit
40 attribute information priority calculation unit
50A, 50B characteristic information determination unit
60 characteristic category categorization unit
70 display control unit
80 storage unit
81 attribute information storage sub-unit
82 attribute usage information storage sub-unit
83 attribute information priority storage sub-unit
84 characteristic category storage sub-unit
85 attribute information level relationship storage sub-unit
100A, 100B content display processing system

1. A content display processing device comprising:
a display unit;
a content acquisition unit configured to acquire a plurality of pieces of content;
an attribute information acquisition unit configured to acquire one or more pieces of attribute information, each of the pieces of attribute information being acquired from one or more of the plurality of pieces of content and indicating an attribute thereof;
a characteristic information determination unit configured to determine a piece of characteristic information based on the pieces of attribute information, the piece of characteristic information pertaining to one or more pieces of target content among the plurality of pieces of content and indicating an attribute which is characteristic thereof; and
a display control unit configured to control the display unit to display the pieces of target content, based on the piece of characteristic information.

2. The content display processing device of claim 1, further comprising
an instruction acquisition unit configured to acquire a piece of instruction information from a user relating to content display, wherein
the characteristic information determination unit determines the piece of characteristic information further based on the piece of instruction information.

3. The content display processing device of claim 2, further comprising
a reliability setting unit configured to set a reliability of each of the pieces of attribute information, based on a type of the piece of attribute information, wherein
the characteristic information determination unit determines the piece of characteristic information further based on the reliabilities of the pieces of attribute information.

4. The content display processing device of claim 3, further comprising:
a first usage information acquisition unit configured to acquire for each of the plurality of pieces of content, a piece of first usage information indicating usage by the user of the piece of content;
a second usage information calculation unit configured to calculate for each of the pieces of attribute information, a piece of second usage information indicating usage by the user of the one or more pieces of content from which the piece of attribute information is acquired; and
a priority calculation unit configured to calculate a priority of each of the pieces of attribute information, based on the reliability and the second usage information thereof, wherein
the second usage information calculation unit calculates the piece of second usage information based on pieces of first usage information of the one or more pieces of content from which the piece of attribute information is acquired, and
the characteristic information determination unit determines the piece of characteristic information further based on the priorities of the pieces of attribute information.

5. The content display processing device of claim 3, further comprising:
a statistical information calculation unit configured to calculate a piece of statistical information of each of the pieces of attribute information, based on a number of pieces of content from which the piece of attribute information is acquired; and
a priority calculation unit configured to calculate a priority of each of the pieces of attribute information, based on the reliability and the piece of statistical information thereof, wherein
the characteristic information determination unit determines the piece of characteristic information further based on the priorities of the pieces of attribute information.

6. The content display processing device of claim 3, wherein
one or more of the pieces of attribute information are manually attached by a user,
the content display processing device further comprises:
a relationship information calculation unit configured to calculate relationship information for each of the pieces of attribute information which is not manually attached, the relationship information indicating a relationship to each of the pieces of attribute information which is manually attached; and
an attribute information priority calculation unit configured to calculate a priority of each of the pieces of attribute information which is manually attached based on the reliability thereof, and calculate a priority of each of the pieces of attribute information which is not manually attached based on the reliability and the relationship information thereof, and
the characteristic information determination unit determines the piece of characteristic information further based on the priorities of the pieces of attribute information which are manually attached and the priorities of the pieces of attribute information which are not manually attached.

7. The content display processing device of claim 4, further comprising
a target content determination unit configured to determine the pieces of target content from among the plurality of pieces of content based on the piece of instruction information which is acquired, wherein
the characteristic information determination unit determines the piece of characteristic information based on pieces of information relating to the pieces of target content.

8. The content display processing device of claim 7, further comprising
a display objective judgment unit configured to judge whether an objective of content display is arrangement or expansion, based on the piece of instruction information which is acquired, wherein
the target content determination unit determines the pieces of target content based on the objective of content display.

9. The content display processing device of claim 3, further comprising
a level information setting unit configured to set a piece of level information of each of the pieces of attribute information, based on the type of the piece of attribute information, wherein
the characteristic information determination unit determines the piece of characteristic information further based on the pieces of level information of the pieces of attribute information.

10. The content display processing device of claim 4, further comprising:
a display objective judgment unit configured to judge whether an objective of content display is arrangement or expansion, based on the piece of instruction information which is acquired; and
a target content determination unit configured to determine the pieces of target content from among the plurality of pieces of content, based on the piece of instruction information which is acquired, wherein
the characteristic information determination unit determines the piece of characteristic information based on the objective of content display and pieces of information relating to the pieces of target content.

11. The content display processing device of claim 3, further comprising:
an accumulation unit configured to accumulate display history information relating to display of each of the pieces of content and usage history information relating to use of each of the pieces of content by the user, the display history information including the piece of instruction information which is acquired; and
a priority calculation unit configured to calculate a priority of each of the pieces of attribute information, based on pieces of the display history information and the usage history information which relate to the one or more pieces of content from which the piece of attribute information is acquired, wherein
the characteristic information determination unit determines the piece of characteristic information further based on the priorities of the pieces of attribute information.

12. The content display processing device of claim 11, wherein
the priority calculation unit calculates the priority of each of the pieces of attribute information further based on time series variation information for the pieces of the display history information and usage history information relating to the pieces of content from which the piece of attribute information is acquired.

13. The content display processing device of claim 12, wherein
the usage history information includes pieces of posting information, searching information and linking information relating to usage of each of the pieces of content by the user via a network.

14. The content display processing device of claim 2, wherein
the display control unit controls the display unit to display the pieces of target content in a manner linked to a user operation performed with regards to content display.

15. The content display processing device of claim 2, wherein
the characteristic information determination unit, when determining the piece of characteristic information, prioritizes pieces of time information, location information, person information, scene information and object information included among the pieces of attribute information.

16. The content display processing device of claim 2, wherein
included among the pieces of attribute information are pieces of metadata information attached automatically to the pieces of content, pieces of analysis information acquired through analysis of the pieces of content and pieces of tag information attached to the pieces of content by a user.

17. A content display processing method comprising:
a content acquisition step of acquiring a plurality of pieces of content;
an attribute information acquisition step of acquiring one or more pieces of attribute information, each of the pieces of attribute information being acquired from one or more of the plurality of pieces of content and indicating an attribute thereof;
a characteristic information determination step of determining a piece of characteristic information based on the pieces of attribute information, the piece of characteristic information pertaining to one or more pieces of target content among the plurality of pieces of content and indicating an attribute which is characteristic thereof; and
a display control step of controlling display of the pieces of target content, based on the piece of characteristic information.

18. A program for causing a computer to execute content display processing, wherein
the content display processing comprises:
a content acquisition step of acquiring a plurality of pieces of content;
an attribute information acquisition step of acquiring one or more pieces of attribute information, each of the pieces of attribute information being acquired from one or more of the plurality of pieces of content and indicating an attribute thereof;
a characteristic information determination step of determining a piece of characteristic information based on the pieces of attribute information, the piece of characteristic information pertaining to one or more pieces of target content among the plurality of pieces of content and indicating an attribute which is characteristic thereof; and
a display control step of controlling display of the pieces of target content, based on the piece of characteristic information.

19. An integrated circuit comprising:
a content acquisition unit configured to acquire a plurality of pieces of content;
an attribute information acquisition unit configured to acquire one or more pieces of attribute information, each of the pieces of attribute information being acquired from one or more of the plurality of pieces of content and indicating an attribute thereof;
a characteristic information determination unit configured to determine a piece of characteristic information based on the pieces of attribute information, the piece of characteristic information pertaining to one or more pieces of target content among the plurality of pieces of content and indicating an attribute which is characteristic thereof; and
a display control unit configured to control display of the pieces of target content, based on the piece of characteristic information.
